(19) United States
(12) Patent Application Publication
(10) Pub. No.: US 2025/0056383 A1
(43) Pub. Date: Feb. 13, 2025

(54) DISCOVERY BURST TRANSMISSION WINDOW FOR SIDELINK COMMUNICATIONS

(71) Applicant: QUALCOMM Incorporated, San Diego, CA (US)

(72) Inventors: Siyi CHEN, Beijing (CN); Jing SUN, San Diego, CA (US); Xiaoxia ZHANG, San Diego, CA (US); Changlong XU, Beijing (CN); Shaozhen GUO, Beijing (CN); Luanxia YANG, Beijing (CN); Hao XU, Beijing (CN)

(21) Appl. No.: 18/717,927

(22) PCT Filed: Mar. 2, 2022
(86) PCT No.: PCT/CN2022/078753

§ 371 Date: Jun. 7, 2024

(51) Int. Cl. H04W 48/10; H04W 56/00; H04W 92/18

(52) U.S. Cl. CPC H04W 48/10; H04W 56/001; H04W 92/18

(57) ABSTRACT

Methods, systems, and devices for wireless communications are described. A first UE may receive a message indicating a configuration or a sidelink discovery burst transmission window. The configuration may include time periods for transmitting multiple sidelink synchronization signals. The first UE may perform a channel access procedure during the sidelink discovery burst transmission window. The first UE may perform the channel access procedure for transmitting one or more of the sidelink synchronization signals according to a pattern indicated by the configuration. The pattern may be based on a quasi co-location relationship between associated pairs of the sidelink synchronization signals. The first UE may transmit the one or more sidelink synchronization signals to a second UE in accordance with the pattern indicated by the configuration.

### CROSS REFERENCE

The present Application is a 371 national stage filing of International PCT Application No. PCT/CN2022/078753 by CHEN et al. entitled “DISCOVERY BURST TRANSMISSION WINDOW FOR SIDELINK COMMUNICATIONS,” filed Mar. 2, 2022, which is assigned to the assignee hereof, and which is expressly incorporated by reference in its entirety herein.

### FIELD OF TECHNOLOGY

The following relates to wireless communications, including a discovery burst transmission window for sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Some communications systems may support sidelink communications, in which a communication device may perform sidelink synchronization signal block (S-SSB) transmissions. In some cases, methods for performing S-SSB transmissions may be deficient.

### SUMMARY

The described techniques relate to improved methods, systems, devices, and apparatuses that support a discovery burst transmission window for sidelink communications. For example, the described techniques provide for configuration of a user equipment (UE) with a sidelink discovery burst window for performing sidelink synchronization signal transmissions. A first UE may receive a message indicating a configuration of a sidelink discovery burst transmission window. The configuration may include time periods for transmitting multiple sidelink synchronization signals. The first UE may perform a channel access procedure during the sidelink discovery burst transmission window. The first UE may perform the channel access procedure for transmitting one or more of the sidelink synchronization signals according to a pattern indicated by the configuration. The pattern may be based on a quasi co-location relationship between associated pairs of the sidelink synchronization signals. The first UE may transmit the one or more sidelink synchronization signals to a second UE in accordance with the pattern indicated by the configuration. As a result, the first UE may improve beam pair selection for sidelink communications with the second UE.

A method for wireless communication at a first UE is described. The method may include receiving a message indicating a configuration of a sidelink discovery burst transmission window including a set of multiple time periods for transmitting a set of multiple sidelink synchronization signals, performing, during the sidelink discovery burst transmission window, at least one channel access procedure for transmitting at least one sidelink synchronization signal of the set of multiple sidelink synchronization signals according to a pattern indicated by the configuration, the pattern based on a quasi co-location relationship between associated pairs of sidelink synchronization signals, and transmitting, to a second UE and in accordance with the pattern indicated by the configuration, the at least one sidelink synchronization signal.

An apparatus for wireless communication at a first UE is described. The apparatus may include a processor, memory coupled with the processor, and instructions stored in the memory. The instructions may be executable by the processor to cause the apparatus to receive a message indicating a configuration of a sidelink discovery burst transmission window including a set of multiple time periods for transmitting a set of multiple sidelink synchronization signals, perform, during the sidelink discovery burst transmission window, at least one channel access procedure for transmitting at least one sidelink synchronization signal of the set of multiple sidelink synchronization signals according to a pattern indicated by the configuration, the pattern based on a quasi co-location relationship between associated pairs of sidelink synchronization signals, and transmit, to a second UE and in accordance with the pattern indicated by the configuration, the at least one sidelink synchronization signal.

Another apparatus for wireless communication at a first UE is described. The apparatus may include means for receiving a message indicating a configuration of a sidelink discovery burst transmission window including a set of multiple time periods for transmitting a set of multiple sidelink synchronization signals, means for performing, during the sidelink discovery burst transmission window, at least one channel access procedure for transmitting at least one sidelink synchronization signal of the set of multiple sidelink synchronization signals according to a pattern indicated by the configuration, the pattern based on a quasi co-location relationship between associated pairs of sidelink synchronization signals, and means for transmitting, to a second UE and in accordance with the pattern indicated by the configuration, the at least one sidelink synchronization signal.

A non-transitory computer-readable medium storing code for wireless communication at a first UE is described. The code may include instructions executable by a processor to receive a message indicating a configuration of a sidelink discovery burst transmission window including a set of multiple time periods for transmitting a set of multiple sidelink synchronization signals, perform, during the sidelink discovery burst transmission window, at least one channel access procedure for transmitting at least one sidelink synchronization signal of the set of multiple sidelink synchronization signals according to a pattern indicated by the configuration, the pattern based on a quasi co-location relationship between associated pairs of sidelink synchronization signals, and transmit, to a second UE and in accordance with the pattern indicated by the configuration, the at least one sidelink synchronization signal.

In some examples of the method, apparatuses, and non-transitory computer-readable medium described herein, the configuration of the sidelink discovery burst transmission window includes an indication of a duration of the sidelink discovery burst transmission window.

Some examples of the method, apparatuses, and non-transitory computer-readable medium described herein may further include operations, features, means, or instructions for receiving radio resource control (RRC) signaling indicating the duration of the sidelink discovery burst transmission window.

Some examples of the method, apparatuses, and non-transitory computer-readable medium described herein may further include operations, features, means, or instructions for transmitting physical sidelink broadcast channel signaling indicating the duration of the sidelink discovery burst transmission window.

Some examples of the method, apparatuses, and non-transitory computer-readable medium described herein may further include operations, features, means, or instructions for determining a duration of the sidelink discovery burst transmission window based on a quasi co-location relation factor indicated by the configuration.

In some examples of the method, apparatuses, and non-transitory computer-readable medium described herein, a value of the duration of the sidelink discovery burst transmission window may be proportional to the quasi co-location relation factor indicated by the configuration.

Some examples of the method, apparatuses, and non-transitory computer-readable medium described herein may further include operations, features, means, or instructions for determining that a value of the quasi co-location relation factor indicated by the configuration may be below a first threshold and calculate a number of candidate sidelink synchronization signal positions within the sidelink discovery burst transmission window based on a measured interference level and determining that the value of the quasi co-location relation factor indicated by the configuration may be below the first threshold.

Some examples of the method, apparatuses, and non-transitory computer-readable medium described herein may further include operations, features, means, or instructions for identifying a default value for a duration of the sidelink discovery burst transmission window based on an indication of the duration being absent from the configuration.

In some examples of the method, apparatuses, and non-transitory computer-readable medium described herein, transmitting the at least one sidelink synchronization signal may include operations, features, means, or instructions for transmitting the at least one sidelink synchronization signal during a first instant of multiple instants for transmitting the set of multiple sidelink synchronization signals, where the sidelink discovery burst transmission window includes the multiple instants for transmitting the set of multiple sidelink synchronization signals.

In some examples of the method, apparatuses, and non-transitory computer-readable medium described herein, transmitting the at least one sidelink synchronization signal may include operations, features, means, or instructions for transmitting the at least one sidelink synchronization signal based on determining a start time for the sidelink discovery burst transmission window in accordance with a sidelink synchronization signal timing offset indicated by the configuration.

Some examples of the method, apparatuses, and non-transitory computer-readable medium described herein may further include operations, features, means, or instructions for identifying a position of a gap slot within the sidelink discovery burst transmission window based on the pattern, the gap slot configured for receiving an indication of a preferred beam to be used for sidelink communications with the second UE.

Some examples of the method, apparatuses, and non-transitory computer-readable medium described herein may further include operations, features, means, or instructions for determining a location of a first symbol for the at least one sidelink synchronization signal based on a subcarrier spacing configured for the first UE.

In some examples of the method, apparatuses, and non-transitory computer-readable medium described herein, a candidate sidelink synchronization signal position for transmitting the at least one sidelink synchronization signal may be based on a subcarrier spacing configured for the first UE and a duration of the sidelink discovery burst transmission window.

In some examples of the method, apparatuses, and non-transitory computer-readable medium described herein, each slot of at least one slot included in the sidelink discovery burst transmission window corresponds to a respective slot index and transmitting a sidelink synchronization signal of the at least one sidelink synchronization signal during a slot may be based on a slot index of the slot.

In some examples of the method, apparatuses, and non-transitory computer-readable medium described herein, transmitting the at least one sidelink synchronization signal may include operations, features, means, or instructions for performing a beam sweep procedure in each instant of multiple instants for transmitting the set of multiple sidelink synchronization signals, where each discovery burst transmission window includes a single instant.

In some examples of the method, apparatuses, and non-transitory computer-readable medium described herein, transmitting the at least one sidelink synchronization signal may include operations, features, means, or instructions for mapping each sidelink synchronization signal of the at least one sidelink synchronization signal to a respective slot of at least one slot included in at least one sidelink discovery burst transmission window, where mapping each sidelink synchronization signal may be based on a signal index associated with each sidelink synchronization signal and a quasi co-location relation factor indicated by the configuration.

In some examples of the method, apparatuses, and non-transitory computer-readable medium described herein, mapping each sidelink synchronization signal of the at least one sidelink synchronization signal may include operations, features, means, or instructions for mapping a first synchronization signal of the at least one sidelink synchronization signal to a first slot in a first position of the sidelink discovery burst transmission window and mapping a second sidelink synchronization signal of the at least one sidelink synchronization signal to a second slot in a second position of the sidelink discovery burst transmission window, where a difference between the first position and the second position may be based on the quasi co-location relation factor indicated by the configuration, and where the first synchronization signal may be quasi co-located with the second sidelink synchronization signal.

A method for wireless communication at a network entity is described. The method may include generating a configuration of a sidelink discovery burst transmission window including a set of multiple time periods for transmitting, between a first UE and a second UE, a set of multiple sidelink synchronization signals, where the configuration indicates a pattern based on a quasi co-location relationship between associated pairs of sidelink synchronization signals and outputting a first indication of the configuration.

An apparatus for wireless communication at a network entity is described. The apparatus may include a processor, memory coupled with the processor, and instructions stored in the memory. The instructions may be executable by the processor to cause the apparatus to generate a configuration of a sidelink discovery burst transmission window including a set of multiple time periods for transmitting, between a first UE and a second UE, a set of multiple sidelink synchronization signals, where the configuration indicates a pattern based on a quasi co-location relationship between associated pairs of sidelink synchronization signals and output a first indication of the configuration.

Another apparatus for wireless communication at a network entity is described. The apparatus may include means for generating a configuration of a sidelink discovery burst transmission window including a set of multiple time periods for transmitting, between a first UE and a second UE, a set of multiple sidelink synchronization signals, where the configuration indicates a pattern based on a quasi co-location relationship between associated pairs of sidelink synchronization signals and means for outputting a first indication of the configuration.

A non-transitory computer-readable medium storing code for wireless communication at a network entity is described. The code may include instructions executable by a processor to generate a configuration of a sidelink discovery burst transmission window including a set of multiple time periods for transmitting, between a first UE and a second UE, a set of multiple sidelink synchronization signals, where the configuration indicates a pattern based on a quasi co-location relationship between associated pairs of sidelink synchronization signals and output a first indication of the configuration.

In some examples of the method, apparatuses, and non-transitory computer-readable medium described herein, the configuration of the sidelink discovery burst transmission window includes a second indication of a duration of the sidelink discovery burst transmission window.

Some examples of the method, apparatuses, and non-transitory computer-readable medium described herein may further include operations, features, means, or instructions for generating RRC signaling indicating the duration of the sidelink discovery burst transmission window.

In some examples of the method, apparatuses, and non-transitory computer-readable medium described herein, a value of the duration of the sidelink discovery burst transmission window may be proportional to a quasi co-location relation factor indicated by the configuration.

In some examples of the method, apparatuses, and non-transitory computer-readable medium described herein, candidate sidelink synchronization signal positions for transmitting the set of multiple sidelink synchronization signals may be based on a subcarrier spacing configured for the first UE and a duration of the sidelink discovery burst transmission window.

### BRIEF DESCRIPTION OF THE DRAWINGS

FIGS. 1 and 2 each illustrate an example of a wireless communications system that supports a discovery burst transmission window for sidelink communications in accordance with one or more aspects of the present disclosure.

FIGS. 3 through 5 each illustrate an example of a timing diagram that supports a discovery burst transmission window for sidelink communications in accordance with one or more aspects of the present disclosure.

FIG. 6 illustrates an example of a process flow that supports a discovery burst transmission window for sidelink communications in accordance with one or more aspects of the present disclosure.

FIGS. 7 and 8 show block diagrams of devices that support a discovery burst transmission window for sidelink communications in accordance with one or more aspects of the present disclosure.

FIG. 9 shows a block diagram of a communications manager that supports a discovery burst transmission window for sidelink communications in accordance with one or more aspects of the present disclosure.

FIG. 10 shows a diagram of a system including a device that supports a discovery burst transmission window for sidelink communications in accordance with one or more aspects of the present disclosure.

FIGS. 11 and 12 show block diagrams of devices that support a discovery burst transmission window for sidelink communications in accordance with one or more aspects of the present disclosure.

FIG. 13 shows a block diagram of a communications manager that supports a discovery burst transmission window for sidelink communications in accordance with one or more aspects of the present disclosure.

FIG. 14 shows a diagram of a system including a device that supports a discovery burst transmission window for sidelink communications in accordance with one or more aspects of the present disclosure.

FIGS. 15 through 18 show flowcharts illustrating methods that support a discovery burst transmission window for sidelink communications in accordance with one or more aspects of the present disclosure.

### DETAILED DESCRIPTION

Some wireless communications systems may support sidelink communications between communication devices, such as user equipments (UEs). In some examples, a UE may communicate using one or more frequency bands associated with a shared radio frequency spectrum, which may be referred to as an unlicensed radio frequency spectrum band. The shared spectrum may include radio frequency bands, which may not be reserved, allocated, or licensed for specific use cases or specific radio access technologies (RATs). In such systems, the UE may perform a channel access procedure, such as a listen-before-talk (LBT) procedure, to gain access to a sidelink bandwidth part (BWP) for performing a sidelink transmission. In some examples, if the channel access procedure is successful, the UE may transmit sidelink synchronization signals, such as sidelink synchronization signal blocks (S-SSBs), to establish a sidelink connection with another communication device (e.g., another UE). For example, the UE may transmit one or multiple S-SSBs to identify a beam pair (e.g., a transmit and a receive beam) for sidelink communications with the other UE.

In some examples, the UE may be configured with multiple contiguous slots (e.g., an S-SSB burst) over a particular duration to transmit the multiple S-SSBs (e.g., perform an S-SSB beam sweep procedure). Each slot of the S-SSB burst may be mapped to a different (e.g., candidate) S-SSB that is associated with a particular beam. Additionally, or alternatively, the UE may be configured with multiple starting positions for performing the S-SSB beam sweep procedure. For example, if the channel access procedure fails prior to a slot for transmitting a first S-SSB, the UE may not transmit the first S-SSB (e.g., associated with a first beam) and may perform another channel access procedure prior to a second slot for transmitting a second S-SSB (e.g., associated with a second beam). As a result, the UE may have a single opportunity to transmit each S-SSB of the S-SSB burst. That is, if the channel access procedure fails prior to the slot for transmitting the first S-SSB associated with the first beam, the UE may not have another opportunity to perform another channel access procedure for transmitting an S-SSB via the first beam (e.g., or via another beam quasi co-located with the first beam). As a result, the reliability of the S-SSB beam sweep procedure may be reduced and the UE may not be capable of identifying a suitable beam pair for sidelink communications with another UE.

Various aspects of the present disclosure relate to a discovery burst transmission window for sidelink communications in an unlicensed radio frequency band. For example, the present disclosure may provide for techniques for configuring a communication device with a sidelink discovery burst window for performing an S-SSB beam sweep procedure that provides multiple channel access procedure attempts per beam. The sidelink discovery burst transmission window may include multiple slots for transmitting candidate S-SSBs over a particular duration (e.g., the duration of the discovery burst transmission window). That is, each slot of the sidelink discovery burst transmission window may be a candidate S-SSB position for transmitting a particular S-SSB. Additionally, or alternatively, the sidelink discovery burst transmission window may be associated with a duty cycle, such that the discovery burst transmission window may be repeated over a time period (e.g., an S-SSB period).

In some examples, the candidate S-SSBs may be mapped to the candidate S-SSB positions according to a pattern. For example, the candidate S-SSBs may be mapped such that the S-SSB beam sweep procedure may be performed multiple times within a single sidelink discovery burst transmission window. In such an example, each S-SSB beam sweep procedure may include a set of multiple (e.g., different) candidate S-SSBs. Additionally, or alternatively, the candidate S-SSBs may be mapped such that the S-SSB beam sweep procedure may be performed multiple times over multiple (e.g., different) discovery burst transmission windows.

In some examples, the candidate S-SSBs may be mapped to candidate S-SSB positions (e.g., slots) of the discovery burst transmission window based on the S-SSB index of each candidate S-SSB. For example, the slot index of a candidate S-SSB position in which a candidate S-SSB is mapped to may depend on the index of the candidate S-SSB. Additionally, or alternatively, the candidate S-SSBs may be mapped to candidate S-SSB positions based on a quasi co-location relationship between associated pairs of the candidate S-SSBs within a same sidelink discovery burst transmission window (or across multiple discovery burst transmission windows). For example, the candidate S-SSB positions of candidate S-SSBs that are quasi co-located may be separated by a number (Q) of positions (e.g., candidate S-SSB positions). As such, if a channel access procedure performed by the UE fails prior to a first candidate S-SSB position (e.g., for transmitting a first candidate S-SSB associated with a first beam), the UE may have another opportunity to transmit an S-SSB via the first beam (e.g., or another beam that is quasi co-located with the first beam) during a subsequent candidate S-SSB position (e.g., slot). As a result, the UE may improve beam pair selection for sidelink communications with other UEs.

Particular aspects of the subject matter described herein may be implemented to realize one or more of the following potential advantages. For example, the techniques employed by the described communication devices may provide benefits and enhancements to wireless communication devices operating within the network, including enabling improved coordination between the wireless communication devices. In some examples, operations performed by the described communication devices may provide improvements to techniques for performing S-SSB beam sweep procedures, thereby improving beam pair selection for sidelink communications between communication devices. The operations performed by the described communication devices to improve beam pair selection for sidelink communications may include configuring a communication device with a sidelink discovery burst transmission window for performing S-SSB beam sweep procedures. In some other implementations, operations performed by the described wireless communication devices may also support improvements to user experience and higher data rates, among other benefits.

Aspects of the disclosure are initially described in the context of wireless communications systems. Aspects of the disclosure are also described in the context of timing diagrams and a process flow. Aspects of the disclosure are further illustrated by and described with reference to apparatus diagrams, system diagrams, and flowcharts that relate to discovery burst transmission window for sidelink communications.

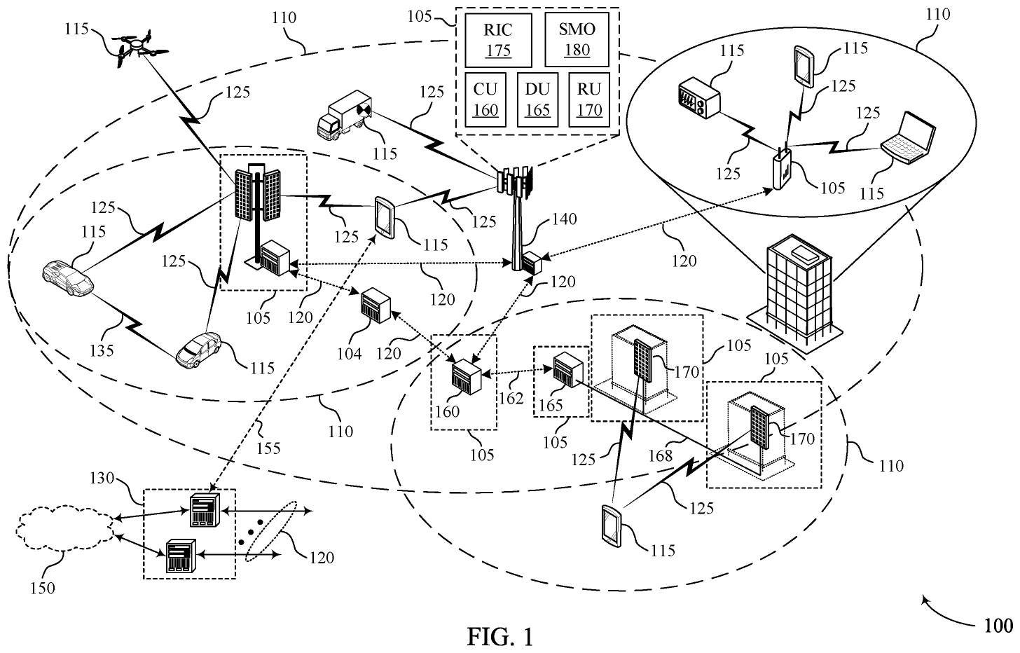

FIG. 1 illustrates an example of a wireless communications system 100 that supports a discovery burst transmission window for sidelink communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support a discovery burst transmission window for sidelink communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may support a discovery burst transmission window for sidelink communications. For example, the described techniques provide for configuration of a communication device (e.g., a UE 115) with a sidelink discovery burst window for performing sidelink synchronization signal transmissions. A first UE 115 may receive a message indicating a configuration of a sidelink discovery burst transmission window. The configuration may include time periods for transmitting multiple sidelink synchronization signals. The first UE 115 may perform a channel access procedure during (or before) the sidelink discovery burst transmission window. The first UE 115 may perform the channel access procedure for transmitting one or more of the sidelink synchronization signals according to a pattern indicated by the configuration. The pattern may be based on a quasi co-location relationship between associated pairs of the sidelink synchronization signals. The first UE 115 may transmit the one or more sidelink synchronization signals to another communication device (e.g., a second UE 115) in accordance with the pattern indicated by the configuration. As a result, the first UE 115 may improve beam pair selection for sidelink communications with the second UE 115.

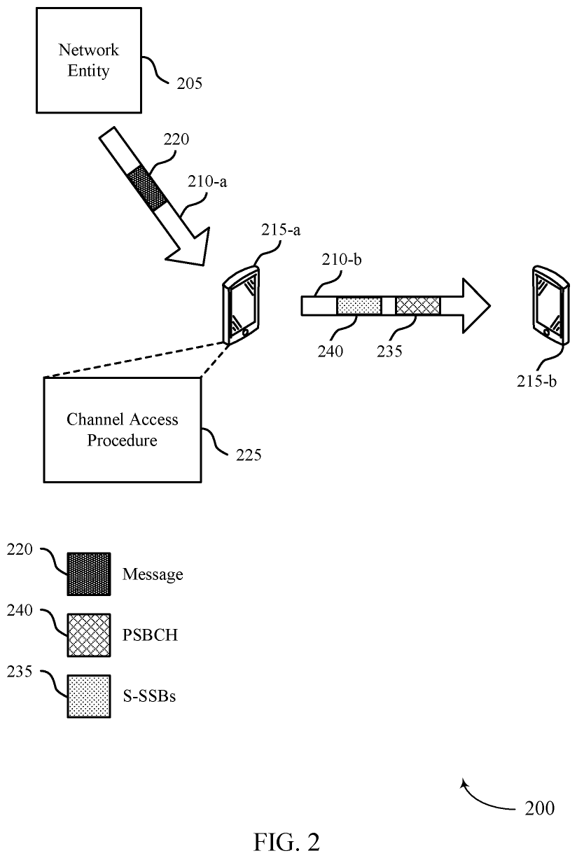

FIG. 2 illustrates an example of a wireless communications system 200 that supports a discovery burst transmission window for sidelink communications in accordance with one or more aspects of the present disclosure. The wireless communications system 200 may implement or be implemented by one or more aspects of the wireless communications system 100. For example, the wireless communications system 200 may include a network entity 205 and one or more UEs 215 (e.g., a UE 215-a and a UE 215-b), which may be examples of the corresponding devices as described with reference to FIG. 1. In the example of FIG. 2, the network entity 205 may be an example of a base station 140, a CU 160, a DU 165, or an RU 170 as described with reference to FIG. 1. The network entity 205 and the UEs 215 may communicate over one or more communication links 210, which may be examples of a communication link 125 as described with reference to FIG. 1. For example, the network entity 205 and the UE 215-a may communicate over a communication link 210-a. In some examples, the network entity 205 may communication with the UE 215-b over another communication link 210 (not shown). The UE 215-a and the UE 215-b may communicate over a communication link 210-b. In the example of FIG. 2, the communication link 210-a may be an example of a downlink (e.g., for communications over a Uu interface) and the communication link 210-b may be an example of a sidelink (e.g., for communications over a PC5 interface).

In some examples of the wireless communications system 100, the network entity 205 may transmit communications, such as reference signals, via a discovery burst. In some examples, a discovery burst may refer to a downlink transmission burst that includes a set of one or multiple signals, one or multiple channels, or both, that may be confined within a window and associated with a duty cycle. That is, the discovery burst may refer to one or multiple transmissions initiated by the network entity 205 (e.g., a gNB) that include one or multiple SSBs (e.g., synchronization signal/physical broadcast channel (SS/PBCH) blocks). For example, the network entity 205 may transmit a discovery burst including one or multiple SSBs to determine a beam pair for communications with one or more of the UEs 215. The SSBs may include a primary synchronization signal (PSS), a secondary synchronization signal (SSS), and a PBCH (e.g., with or multiple associated demodulation reference signals (DMRSs)). In some examples, the SSB may include a control resource set (CORESET) for physical downlink control channel (PDCCH) scheduling of physical downlink shared channel (PDSCH) transmissions carrying a system information block (SIB), such as a SIB1. In some examples, the PDSCH may carry the SIB1, non-zero power channel state information (CSI) reference signals (CSI-RSs), or both.

In some examples, a time duration of the window over which the discover burst is transmitted (e.g., in which the set of signals are confined) may be configured (e.g., up to a maximum time duration or an otherwise suitable time duration). For example, the time duration of the window (e.g., a discover burst transmission window, a discover reference signal (DRS) transmission window) may be configured (e.g., by the network) as value up to about 5 ms (e.g., 0.5, 1, 2, 3, 4, or 5 ms). In some examples, if the time duration of the discovery burst transmission window is not known to one or more UEs 215, the one or more UEs 215 may determine the duration of the discovery burst transmission window to be a default value (e.g., of about 5 ms).

Additionally or alternatively, the discovery burst transmission window may include a number of slots for transmitting SSBs (e.g., a number (Y) of candidate SSB positions). In some examples, the number (e.g., a maximum number or an otherwise suitable number) of candidate SSB positions within the discovery burst transmission window may be selected based on a subcarrier spacing configured for one or more of the UE 215 (e.g., Y=10 for a 15 kHz subcarrier spacing or Y=20 for a 30 kHz subcarrier spacing). In some examples, a first candidate SSB position of the discover burst transmission window may be located at a first portion (e.g., half) of slots within a portion of a frame (e.g., a half frame).

In some examples, the discovery burst transmission window may provide repeating (e.g., wrap around) transmission opportunities for quasi co-located SSBs within the discovery burst transmission window. For example, if a channel access procedure performed by the network entity 205 for transmitting an SSB associated with a particular beam, the network entity may have another (e.g., subsequent) opportunity to transmit an SSB via the same beam (e.g., or another beam that is quasi co-located with the beam) during the discovery burst transmission window. That is, for an SSB with a particular quasi co-location relationship, if the channel access procedure (e.g., an LBT procedure) fails for transmission of the SSB, another opportunity for transmission of the SSB may occur in the same discovery burst transmission window. In some examples, the quasi co-location relationship between SSBs may be known to the network entity 205 (e.g., by an indication, such as a Q factor indication).

Additionally or alternatively, in some examples of the wireless communications system 100, the UE 215-a may transmit S-SSBs to identify a beam pair for communications with the UE 215-b. In some examples, an S-SSB may have a bandwidth that includes a number (e.g., about 11) of physical resource blocks (PRBs). For example, a physical sidelink broadcast channel (PSBCH) of the S-SSB may include a number (e.g., about 11) of PRBs and a number of OFDM symbols. In some examples, S-SSBs with a normal cyclic prefix may include a number (e.g., about 9) of OFDM symbols that may be different from the number (e.g., about 7) of OFDM symbols for S-SSBs with an extended cyclic prefix. In some example, a first PSBCH symbol of an S-SSB may be used (e.g., by the UE 215-b) for automatic gain control (AGC) training. Additionally or alternatively, the PSBCH may include a payload including a number (e.g., about 56) of bits. In some examples, the bits of the PSBCH may be allocated according to the following Table 1:

TABLE 1

| PBSCP Contents | Number of bits |
|---|---|
| Direct frame number | 10 |
| Indication of time division | 12 |
| duplex configuration | |
| Slot index | 7 |
| In-coverage indicator | 1 |
| Reserve bits | 2 |
| Cyclic redundancy check | 24 |
| Total bits | 56 |

In some examples, a sidelink PSS (S-PSS) of the S-SSB may include a sequence (e.g., an m-sequence) that may include a number (e.g., about 127) of values. Additionally, or alternatively, a generator (e.g., and the initial values) used for the S-PSS may be a same generator (e.g., the same values) used for PSSs transmitted via the Uu interface (e.g., included in an SSB). For example, the S-PSS may be generated with a cyclic shift (e.g., of about 22 or about 65) and may be repeated on consecutive symbols (e.g., two consecutive symbols). In some examples, a sidelink SSS (e.g., S-SSS) of the S-SSB may include a sequence (e.g., a gold sequence) that may include a number (e.g., about 127) of values. Additionally, or alternatively, a generator (e.g., and the initial values and the cyclic shifts) used for the S-SSS may be a same generator (e.g., the same values) used for SSS transmitted via the Uu interface (e.g., included in an SSB). For example, the S-SSS may be repeated on consecutive symbols (e.g., two consecutive symbols). In some examples, DMRS of the S-SSB may be included in PSBCH symbols (e.g., each PSBCH symbol) and occur periodically. For example, the DMRSs may be repeated after a number (e.g., about four) of resource elements.

In some examples, the UE 215-a may transmit S-SSBs as part of an S-SSB beam sweep procedure. To support an S-SSB beam sweep, the UE 215-a may, in some examples, utilize S-SSB slots (e.g., candidate S-SSB positions) which are mapped to multiple (e.g., different) beams. For example, the UE 215-a may increase the number (K) of S-SSBs within an S-SSB period (e.g., for a frequency range, such as FR1). In some examples, the UE 215-a may increase K to a value based on the subcarrier spacing configured for the UE 215-a (e.g., K={1, 2, 4} for a subcarrier spacing of 30 kHz or K={1, 2, 4, 8} for a subcarrier spacing of 60 kHz).

In other examples, the UE 215-a may be configured to use multiple contiguous S-SSB slots (e.g., an S-SSB burst) in each S-SSB instance for performing the S-SSB beam sweep procedure. In some examples, the number of S-SSB slots in the S-SSB burst may be based on a subcarrier spacing configured for the UE 215-a. For example, for a subcarrier spacing of 30 kHz, four S-SSB slots may be included within a single S-SSB burst, which may enable the UE 215-a to sweep up to four beams. In some examples, the UE 215-a may perform the S-SSB beam sweep procedure a number of times (e.g., twice) within a period of time (e.g., an S-SSB period of about 160 ms). Additionally, or alternatively, a time interval between two instances in which the UE 215-a may perform the S-SSB beam sweep procedure (e.g., S-SSB instances) may be selected (e.g., by the UE 215-a or indicated to the UE 215-a by the network), such that multiple S-SSB bursts may not overlap (e.g., in time). In some examples, the time interval between S-SSB instances may be communicated between communication devices (e.g., between the network entity and the UE 215-a or between the UE 215-a and the UE 215-b) via an instruction element (IE), such as the sl-TimeInterval IE.

In some examples, a window for transmitting an S-SSB burst may provide multiple starting positions (e.g., opportunities for performing channel access procedures such as LBT procedures) for a number (K) of contiguous S-SSBs to be transmitted. For example, for a given value of K, the number of starting positions for transmitting S-SSBs within an S-SSB burst may be based on the frequency range over which the S-SSBs are to be transmitted, the number of slots for transmitting S-SSBs (e.g., the number (Y) of candidate S-SSB positions), the subcarrier spacing configured for the UE 215-a, or any combination thereof. For example, the number of starting positions (e.g., positions for performing an LBT procedure, LBT positions) may be greater than or equal to two (e.g., for FR1, a subcarrier spacing of 15 kHz, K=1, and Y=2), greater than or equal to 3 (e.g., for FR1, a subcarrier spacing of 30 kHz, K=2, and Y=4), or greater than or equal to 4 (e.g., for FR1, a subcarrier spacing of 60 kHz, K=4, and Y=8). In some examples (e.g., with the window for transmitting an S-SSB burst), the transmitted PSBCH may include a slot number or a DMRS scrambling sequence that may indicate the S-SSB beam index (e.g., for each S-SSB transmitted in the S-SSB beam sweep procedure).

In some examples, while the window for transmitting an S-SSB burst may provide multiple starting positions, each slot of the S-SSB burst may be mapped to a different S-SSB that is associated with a particular beam. As such, the UE 215-a may have a single opportunity to transmit each S-SSB of the S-SSB burst. For example, for a given frequency range (e.g., FR1), S-SSB beam sweep procedures may be performed relatively infrequently. However, for some communication devices (e.g., roadside units (RSU)) S-SSB beam sweep procedures may improve the coverage and link quality for sidelink communications within a wireless communications system (e.g., the wireless communications system 100). For example, an S-SSB burst may provide multiple starting positions to prevent channel access procedure (e.g., LBT procedure) failures and may not consider quasi co-location relationships between S-SSBs to be transmitted in the S-SSB burst. As such, the UE 215-a may have a single opportunity to transmit each S-SSB of the S-SSB burst. For example, for a given S-SSB with particular quasi co-location relationship, if the channel access procedure fails for transmission of the S-SSB, there may not be another opportunity in the same window to transmit the S-SSB. Therefore, methods for S-SSB beam sweep procedures which utilize quasi co-location relationships between S-SSBs may be desirable.

In some examples, a discovery burst transmission window for sidelink communications in an unlicensed radio frequency band (e.g., a sidelink discovery burst transmission window), as described herein, may provide one or more enhancements to S-SSB beam sweep procedures. For example, the sidelink discovery burst transmission window may consider quasi co-location relationships between S-SSBs to be transmitted during the S-SSB beam sweep procedure. In some examples, the sidelink discovery burst transmission window may be configured according to multiple (e.g., different) patterns (e.g., S-SSB patterns). Additionally, or alternatively, the number of candidate S-SSB positions (e.g., slots for transmitting candidate S-SSBs) within the sidelink discovery burst transmission window may depend on the configured S-SSB pattern. Additionally, or alternatively, the pattern may be based on a quasi co-location relationship between associated pairs of the candidate S-SSBs (e.g., candidate S-SSB positions).

In some examples, the network (e.g., one or more network entities 205) may configure the UE 215-a with a sidelink discovery burst transmission window for sidelink communications over an unlicensed or shared radio frequency band. For example, the UE 215-a may receive a message 220 indicating a configuration of a sidelink discovery burst transmission window from the network entity 205. In some examples, the sidelink discovery burst window may refer to (e.g., be an example of) a sidelink transmission burst that may include one or multiple S-SSBs confined within a window and associated with a duty cycle. For example, the configuration may include time periods (e.g., slots) for transmitting one or more sidelink synchronization signals (e.g., one or more S-SSBs 240). Additionally, or alternatively, the configuration may include an indication of a duration for the sidelink discovery burst transmission window. For example, the duration (e.g., temporal length) of the sidelink discovery burst transmission window may be indicated to (e.g., configured for) the UE 215-a by the network (e.g., one or more network entities 205), such as through RRC signaling. That is, in some examples, the message 220 may be an RRC message. Additionally, or alternatively, the UE 215-a may be configured (e.g., preconfigured, hardcoded) with a quasi co-location relation factor (Q) for determining the duration for the sidelink discovery burst transmission window. For example, the duration for the sidelink discovery burst transmission window may be proportional to the value of Q.

In some examples, the UE 215-a may adjust (e.g., perform a relatively fine adjustment) of the sidelink discovery burst transmission window duration based on the value of Q. For example, for decreased values of Q (e.g., relatively small values of Q), the UE 215-a may reduce the number of candidate S-SSB positions (e.g., the number of slots for transmitting candidate S-SSBs) within the sidelink discovery burst transmission window. For example, if the value of Q fails to satisfy a threshold, the UE 215-a may calculate a number of candidate S-SSB positions within the sidelink discovery burst transmission window based on a measured interference level (e.g., at the UE 215-a or the UE 215-b) and the value of Q. As such, the UE 215-a may reduce the number of S-SSBs to be detected by the UE 215-b (e.g., the receiving UE). In some examples, the UE 215-a may adjust the number of candidate S-SSB positions in accordance with the following Table 2:

TABLE 2

| | | Sidelink discovery burst |
|---|---|---|
| Number of candidate | | transmission window |
| S-SSBs | Q | duration |
| 8 | 8 | 10 ms |
| 4 | 4 | 5 ms |

Additionally, or alternatively, the UE 215-a may determine (e.g., identify) a default value for the duration of the sidelink discovery burst transmission window, for example based on an indication of the duration being absent from the configuration. That is, the UE 215-a may determine a default value (e.g., about 10 ms, a frame) for the duration of the sidelink discovery burst transmission window if the duration is not configured (e.g., via the RRC message). In some examples, the UE 215-a may indicate the duration for the sidelink discovery burst transmission window to another communication device. For example, the UE 215-a may indicate the duration for the sidelink discovery burst transmission window to the UE 215-b in a PSBCH 235 (e.g., via two reserved bits in the PSBCH 235).

The UE 215-a may perform a channel access procedure 225 during or before the sidelink discovery burst transmission window. In some examples, the channel access procedure 225 may be an LBT procedure. In some examples, the UE 215-a may perform the channel access procedure 225 to gain access to a sidelink BWP for transmitting one or more of the S-SSBs 240 according to a pattern indicated by the configuration. The pattern may be based on a quasi co-location relationship (e.g., the quasi co-location relation (Q)) between associated pairs of the S-SSBs 240. The UE 215-a may transmit the one or more S-SSBs 240 to the UE 215-b in accordance with the pattern indicated by the configuration. As a result, the UE 215-a may improve beam pair selection for sidelink communications with the UE 215-b.

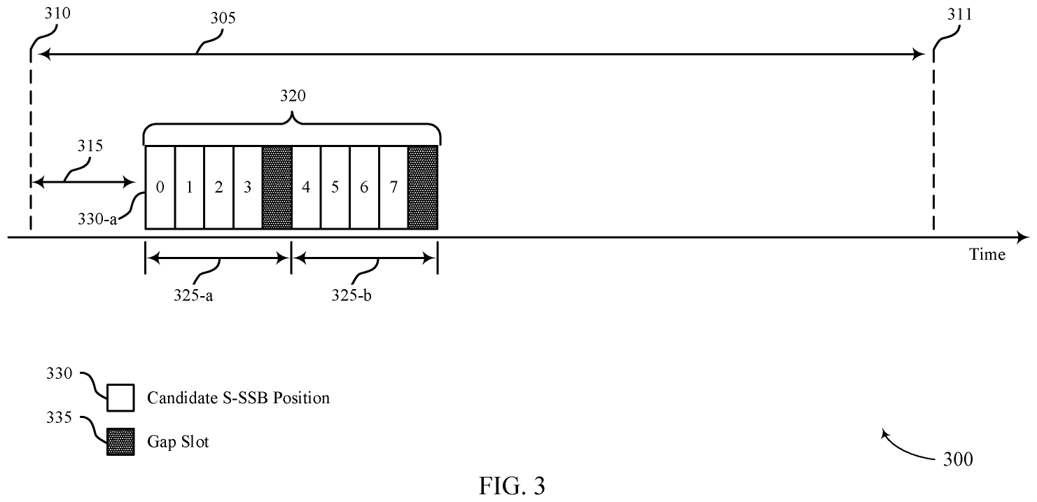

FIG. 3 illustrates an example of a timing diagram 300 that supports a discovery burst transmission window for sidelink communications in accordance with one or more aspects of the present disclosure. The timing diagram 300 may implement or be implemented by one or more aspects of the wireless communications system 100 and the wireless communications system 200. For example, the timing diagram 300 may be implemented by a network entity 105 or a UE 115, which may be examples of the corresponding devices as described with reference to FIGS. 1 and 2.

In some examples, the network (e.g., the network entities 105) may configure the UE 115 with a sidelink discovery burst transmission window 320 for sidelink communications over an unlicensed radio frequency band. In some examples, the sidelink discovery burst transmission window 320 may include time periods for transmitting candidate S-SSBs (e.g., one or more candidate S-SSB positions 330). In the example of FIG. 3, the sidelink discovery burst transmission window 320 may include a number (e.g., 8) of candidate S-SSB positions 330 that may each be associated with a corresponding index (e.g., index 0 through 7) and a number (e.g., two) of gap slots 335. In some examples, the UE 115 may transmit S-SSBs (e.g., to another UE 115) during the sidelink discovery burst transmission window 320 and according to a pattern (e.g., an S-SSB pattern). In some examples, the S-SSB pattern may provide for multiple (e.g., more than one) channel access procedure attempt (e.g., LBT attempt) per beam (e.g., associated with a candidate S-SSB) within a same sidelink discovery burst transmission window 320. For example, the UE 115 may perform an S-SSB beam sweep procedure in an S-SSB instant (e.g., an S-SSB instant 325-a or an S-SSB instant 325-b) and multiple S-SSB instants 325 may occur (e.g., be located) in a single sidelink discovery burst transmission window.

In some examples, the UE 115 may determine that transmission of an S-SSB in a frame (e.g., of a duration of about 10 ms) may be within a single sidelink discovery burst transmission window (e.g., the single sidelink discovery burst transmission window 320) that starts from a first symbol of a first slot in the frame. That is, a first S-SSB to be transmitted in the sidelink discovery burst transmission window 320, may be transmitted in the first symbol of the first candidate S-SSB position (e.g., a candidate S-SSB position 330-a). In some examples, the first candidate S-SSB position 330-a (e.g., associated with index 0) of the sidelink discovery burst transmission window 320 may occur according to an offset 315. The offset 315 may be a frame-level offset, for example indicated to the UE 115 via an IE, such as the sl-TimeOffsetSSB IE. In some examples, the offset 315 may be measured from a start time 310 of an S-SSB period 305. The S-SSB period 305 may be of a duration (e.g., about 160 ms) between the start time 310 and an end time 311.

In some examples, one or more gap symbols (e.g., internal gap symbols, not shown) may occur between candidate S-SSB position 330. For example, the internal gap symbols may be occupied by (e.g., filled with) PSBCH rate matching or repetitions. Additionally, or alternatively, one or more gap slots 335 may occur (e.g., be reserved) between the S-SSB instants 325. That is, the last slot of the S-SSB instant 325-a and the S-SSB instant 325-b may be a gap slot 335. In some examples, the gap slots 335 may enable (e.g., provide an opportunity for) other UEs 115 (e.g., receiving UEs 115) to indicate a preferred S-SSB transmit beam (e.g., a preferred or an otherwise suitable beam pair for communications with the UE 115) with a reduced (e.g., relatively short) latency. Additionally, or alternatively, the gap slots 335 may provide an opportunity for the other UE 115 to perform data transmission, such as for latency-reduced communications (e.g., ultra-reliable low latency communications (URLLC)).

In some examples, the UE 115 may determine a location of a first symbol for transmitting an S-SSB (e.g., a candidate S-SSB) in the sidelink discovery burst transmission window 320 based on a subcarrier spacing configured for the UE 115. That is, the first symbol of each candidate S-SSB position 330 may be indexed according to a subcarrier spacing configured for the UE 115. For example, if the UE 115 is configured for a subcarrier spacing of 15 kHz, the index of the first symbol of each candidate S-SSB position 330 may be determined according to the following Equation 1:

$$0 + 14 n , n = 0 ∼ ( X - 1 ) , X = 10 \qquad ( 1 )$$

where X may represent the number of slots (e.g., candidate S-SSB positions 330) within the sidelink discovery burst transmission window 320 (e.g., including the gap slots 335). Additionally, or alternatively, if the UE 115 is configured for a subcarrier spacing of 30 kHz, the index of the first symbol of each candidate S-SSB position 330 may be determined according to the following Equation 2:

$$0 + 14 n , n = 0 ∼ ( \frac{X}{2} - 2 ) , \frac{X}{2} ∼ ( X - 2 ) , X = 20 \qquad ( 2 )$$

Additionally, or alternatively, if the UE 115 is configured for a subcarrier spacing of 60 kHz, the index of the first symbol of each candidate S-SSB position 330 may be determined according to the following Equation 3:

$$0 + 14 n , n = 0 ∼ ( \frac{X}{4} - 2 ) , \frac{X}{4} ∼ ( \frac{X}{2} - 2 ) , \frac{X}{2} ∼ ( \frac{3}{2} X - 2 ) , \frac{3 X}{4} ∼ ( X - 2 ) , X = 40 \qquad ( 3 )$$

In some examples, the UE 115 may determine the number of candidate S-SSB positions 330 within the sidelink discovery burst transmission window 320 based on the length of the sidelink discovery burst transmission window 320 and a subcarrier spacing configured for the UE 115. For example, the number (Y) of candidate S-SSB positions 330 within the sidelink discovery burst transmission window 320 may be indexed from 0 to Y-1 and may be determined according to the following Table 3:

TABLE 3

| Sidelink discovery | Number of candidate S-SSB positions | | |
|---|---|---|---|
| burst transmission | 15 kHz sub- | 30 kHz sub- | 60 kHz sub- |
| window duration | carrier spacing | carrier spacing | carrier spacing |
| 10 ms | 10 | 18 | 36 |
| 5 ms | 5 | 8 | 16 |

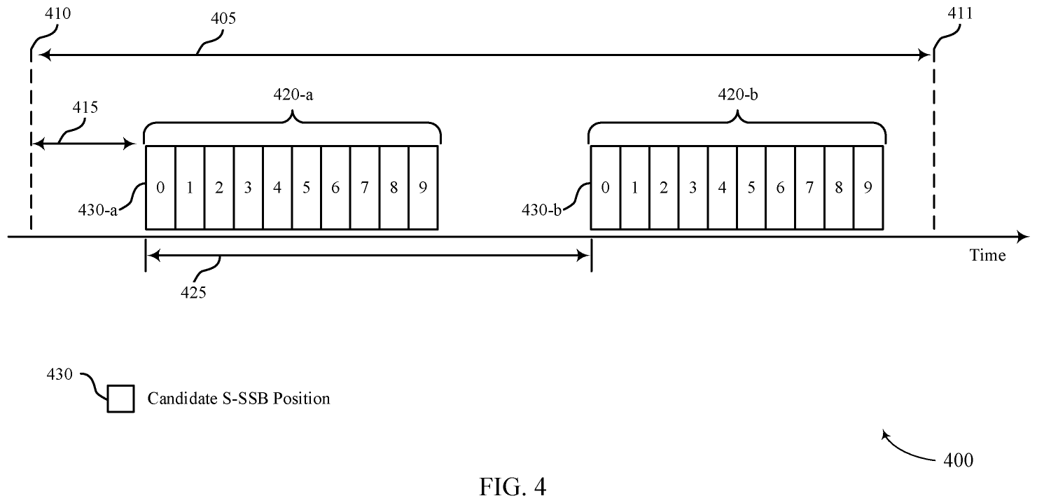

FIG. 4 illustrates an example of a timing diagram 400 that supports a discovery burst transmission window for sidelink communications in accordance with one or more aspects of the present disclosure. The timing diagram 400 may implement or be implemented by one or more aspects of the wireless communications system 100 and the wireless communications system 200. For example, the timing diagram 400 may be implemented by a network entity 105 or a UE 115, which may be examples of the corresponding devices as described with reference to FIGS. 1 and 2.

In some examples, the network (e.g., one or more network entities 105) may configure the UE 115 with multiple sidelink discovery burst transmission windows (e.g., a sidelink discovery burst transmission window 420-a and a sidelink discovery burst transmission window 420-b) for sidelink communications over an unlicensed radio frequency band. In some examples, the sidelink discovery burst transmission window 420-a and the sidelink discovery burst transmission window 420-b may each include time periods for transmitting candidate S-SSBs (e.g., one or more candidate S-SSB positions 430). In some examples of FIG. 4, the sidelink discovery burst transmission window 420-a and the sidelink discovery burst transmission window 420-b may each include a number (e.g., 10) candidate S-SSB positions 430 that may each be associated with a corresponding index (e.g., index 0 through 9). In some examples, the UE 115 may transmit S-SSBs (e.g., to another UE 115) during the sidelink discovery burst transmission window 420-a, the sidelink discovery burst transmission window 420-b, or both, and according to a pattern (e.g., an S-SSB pattern). In some examples, the S-SSB pattern may provide for multiple (e.g., more than one) channel access procedure attempt (e.g., LBT attempt) per beam (e.g., associated with a candidate S-SSB) within a same sidelink discovery burst transmission window (e.g., the sidelink discovery burst transmission window 420-a or the sidelink discovery burst transmission window 420-b). For example, the UE 115 may perform an S-SSB beam sweep procedure in an S-SSB instant 425 that may include a single sidelink discovery burst transmission window (e.g., the sidelink discovery burst transmission window 420-a). That is, different S-SSB instants may be located in different sidelink discovery burst transmission windows and multiple sidelink discovery burst transmission windows (e.g., the sidelink discovery burst transmission window 420-a and the sidelink discovery burst transmission window 420-b) may be configured for (e.g., transmitted for, indicated to) the UE 115.

In some examples, the UE 115 may determine that transmission of an S-SSB in a frame (e.g., of a duration of about 10 ms) may be within a single sidelink discovery burst transmission window (e.g., the sidelink discovery burst transmission window 420-a or the sidelink discovery burst transmission window 420-b) that starts from a first symbol of a first slot in the frame. That is, a first S-SSB to be transmitted (e.g., the first candidate S-SSB) in the sidelink discovery burst transmission window 420-a, may be transmitted in the first symbol of a candidate S-SSB position 430-a and a first S-SSB to be transmitted in the sidelink discovery burst transmission window 420-b, may be transmitted in the first symbol of a candidate S-SSB position 430-b. In some examples, the first candidate S-SSB position 430-a and the first candidate S-SSB position 430-b may each be associated with the index 0. Additionally, or alternatively, the first candidate S-SSB position 430-a may occur according to an offset 415. The offset 415 may be an example of an offset described with reference to FIG. 3. For example, the offset 415 may be indicated to the UE 115 via an IE, such as the sl-TimeOffsetSSB IE. Additionally, or alternatively, the offset 415 may be measured from a start time 410 of an S-SSB period 405. The S-SSB period 405 may be an example of an S-SSB period described with reference to FIG. 3, for example the S-SSB period 405 may be of a duration (e.g., about 160 ms) between the start time 410 and an end time 411.

In some examples, one or more gap symbols (e.g., internal gap symbols, not shown) may occur between candidate S-SSB positions 430. For example, the internal gap symbols may be occupied by (e.g., filled with) PSBCH rate matching or repetitions. In some examples, a time for establishing a beam pair link (e.g., with another UE 115) may be reduced by increasing the number of candidate S-SSB positions 430 within the sidelink discovery burst transmission windows 420. That is, enhancements for beam pair link establishment may be achieved by increasing the density of S-SSB transmissions.

In some examples, the UE 115 may determine a location of a first symbol for transmitting an S-SSB (e.g., a candidate S-SSB) in the sidelink discovery burst transmission windows 420 based on a subcarrier spacing configured for the UE 115. That is, the first symbol of each candidate S-SSB position 430 may be indexed according to a subcarrier spacing configured for the UE 115. For example, if the UE 115 is configured for a subcarrier spacing of 15 kHz, the index of the first symbol of each candidate S-SSB position 430 may be determined according to the following Equation 4:

$$0 + 14 n , n = \{ 0 , 1 , 2 , 3 , 4 , 5 , 6 , 7 , 8 , 9 \} \qquad ( 4 )$$

where n may represent the number of slots (e.g., candidate S-SSB positions 430) within each of the sidelink discovery burst transmission windows 420. Additionally, or alternatively, if the UE 115 is configured for a subcarrier spacing of 30 kHz, the index of the first symbol of each candidate S-SSB position 430 may be determined according to the following Equation 5:

$$0 + 14 n , n = \{ 0 , 1 , 2 , 3 , 4 , 5 , 6 , 7 , 8 , 9 , … , 19 \} \qquad ( 5 )$$

Additionally, or alternatively, if the UE 115 is configured for a subcarrier spacing of 60 kHz, the index of the first symbol of each candidate S-SSB position 430 may be determined according to the following Equation 6:

$$0 + 14 n , n = \{ 0 , 1 , 2 , 3 , 4 , 5 , 6 , 7 , 8 , 9 , … , 39 \} \qquad ( 6 )$$

In some examples, the UE 115 may determine the number of candidate S-SSB positions 430 within each of the sidelink discovery burst transmission windows 420 based on the respective length of the sidelink discovery burst transmission windows 420 and a subcarrier spacing configured for the UE 115. For example, the number (Y) of candidate S-SSB positions 430 within each of the sidelink discovery burst transmission windows 420 may be indexed from 0 to Y-1 and may be determined according to the following Table 4:

TABLE 4

| Sidelink discovery | Number of candidate S-SSB positions | | |
|---|---|---|---|
| burst transmission | 15 kHz sub- | 30 kHz sub- | 60 kHz sub- |
| window duration | carrier spacing | carrier spacing | carrier spacing |
| 10 ms | 10 | 20 | 40 |
| 5 ms | 5 | 10 | 20 |

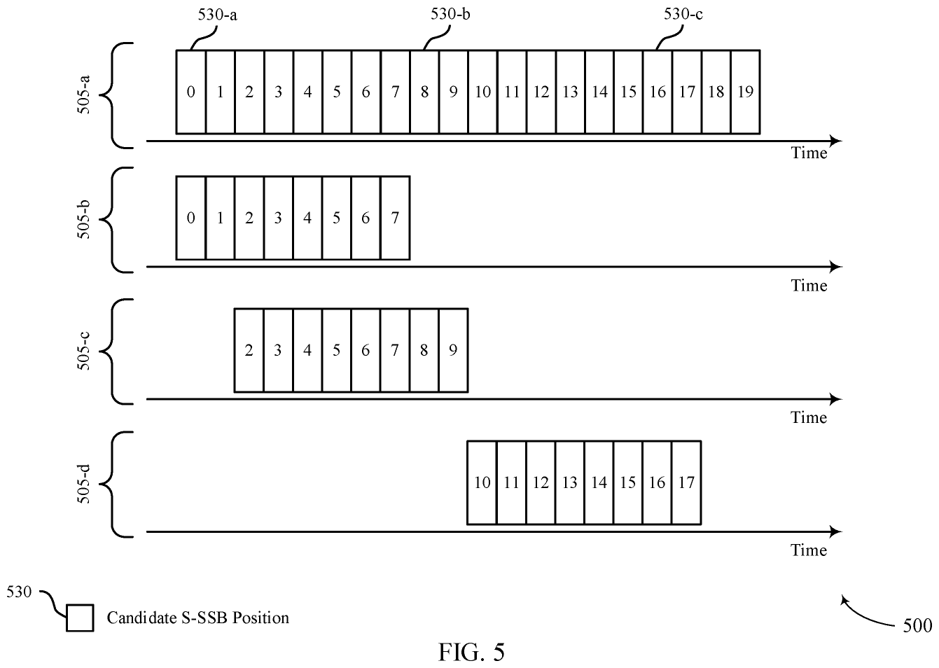

FIG. 5 illustrates an example of a timing diagram 500 that supports a discovery burst transmission window for sidelink communications in accordance with one or more aspects of the present disclosure. The timing diagram 500 may implement or be implemented by one or more aspects of the wireless communications system 100 and the wireless communications system 200. For example, the timing diagram 500 may be implemented by a network entity 105 or a UE 115, which may be examples of the corresponding devices as described with reference to FIGS. 1 and 2.

In some examples, the network (e.g., one or more network entities 105) may configure the UE 115 with one or multiple sidelink discovery burst transmission windows for sidelink communications over an unlicensed radio frequency band. In some examples, a sidelink discovery burst transmission window configured by the network may include a number of candidate S-SSB positions 530 for transmitting S-SSBs. In some examples, the UE 115 may transmit one or multiple S-SSBs in a number of candidate S-SSB positions 530 according to one or more candidate S-SSB repetition schemes 505 (e.g., a candidate repetition scheme 505-a, a candidate repetition scheme 505-b, a candidate repetition scheme 505-c, or a candidate repetition scheme 505-d). In some examples, the candidate S-SSB positions 530 represented in the candidate S-SSB repetition schemes 505 may occur over a one or multiple sidelink discovery burst transmission windows. The one or multiple sidelink discover burst transmission windows may be examples of sidelink discovery burst transmission windows described with reference to FIGS. 2 through 4.

In some examples, the candidate S-SSB positions 530 may be configured according to a pattern indicated by the network (e.g., one or more network entities 105). In some examples, the pattern may be based on a quasi co-location relation (Q) between associated pairs of the S-SSBs. For example, the candidate S-SSB positions 530 may occur such that candidate S-SSB positions 530 which are Q positions apart may be quasi co-located. In some examples, the quasi co-location factor (Q) may range from about 1 to about 8 (e.g., Q={1, 2, 4, 8}). In some examples, the UE 115 may be configured with a number (e.g., 20) of candidate S-SSB positions 530 for transmitting (e.g., planned for transmitting) S-SSBs that may each be associated with a corresponding index (e.g., index 0 through 19). That is, the UE 115 may use each candidate S-SSB positions 530 represented by the candidate repetition scheme 505-a to transmit a candidate S-SSB that is associated with a particular beam. In the example of FIG. 5, the value of Q may be 8. As such, candidate S-SSBs mapped to candidate S-SSB positions 530 that are separated by 8 positions may be quasi co-located.

For example, a candidate S-SSB mapped to the candidate S-SSB position 530-a (e.g., associated with index 0) may be quasi co-located with a candidate S-SSB mapped to a candidate S-SSB position 530-b (e.g., associated with index 8) and a candidate S-SSB mapped to a candidate S-SSB position 530-c (associated with index 16). Therefore, if the UE 115 is not capable of transmitting one or more candidate S-SSBs over the candidate S-SSB positions 530 represented by the candidate repetition scheme 505-b (e.g., due to a channel access procedure failure) the UE 115 may have multiple (e.g., subsequent) opportunities for transmitting the one or more candidate S-SSBs (e.g., via a same beam or a quasi co-located beam) over the candidate S-SSB positions 530 represented by the candidate repetition scheme 505-c or the candidate S-SSB positions 530 represented by the candidate repetition scheme 505-d. In some examples, the quasi co-location factor (Q) may be configured at the UE 115 (e.g., pre-configured or indicated to the UE 115 by the network via an RRC configuration).

In some examples, another UE 115 (e.g., a receiving UE 115) may determine that S-SSBs transmitted from the UE 115 (e.g., within a same sidelink discovery burst transmission window or across multiple (e.g., different) sidelink discovery burst transmission windows) are quasi co-located, for example if a value of a parameter (e.g., as determined by an n (S SSB) mod Q IE, where n_(S-SSB) may represent the candidate S-SSB index) associated with (e.g., among) the S-SSBs is the same (e.g., equal). In some examples, there may be a mapping (e.g., fixed mapping) between the index of candidate S-SSB positions 530 (e.g., the slot index) and the index of the candidate S-SSBs (e.g., the candidate S-SSB index). As such, the candidate S-SSB index may be determined (e.g., deduced) based on the index of candidate S-SSB positions 530.

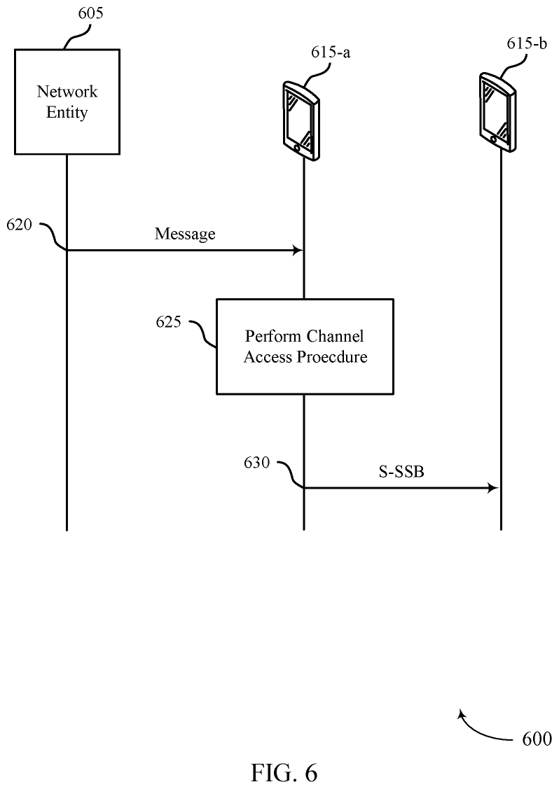

FIG. 6 illustrates an example of a process flow 600 that supports a discovery burst transmission window for sidelink communications in accordance with one or more aspects of the present disclosure. For example, the process flow 600 may include example operations associated with a UE 615-a, a UE 615-b, and a network entity 605, which may be examples of the corresponding devices as described with reference to FIGS. 1 and 2. The operations performed by the UE 615-a, the UE 615-b, and the network entity 605 may support improvements to communications between one or both of the UEs 615 and the network, among other benefits. In the following description of the process flow 600, operations between the UE 615-a, the UE 615-b, and the network entity 605 may occur in a different order or at different times than as shown. Some operations may also be omitted from the process flow 600, and other operations may be added to the process flow 600.

At 620, the UE 615-a may receive (e.g., from the network entity 605) a message indicating a configuration of a sidelink discovery burst transmission window. The sidelink discover burst transmission window may be an example of a sidelink discovery burst transmission window described with reference to FIGS. 2 through 5. For example, the sidelink discovery burst transmission window may include multiple time periods for transmitting sidelink synchronization signals (e.g., may include multiple candidate S-SSB positions). At 625, the UE 615-a may perform one or more channel access procedures (e.g., LBT procedures) for transmitting one or more sidelink synchronization signals (e.g., S-SSBs) according to a pattern indicated by the configuration. In some examples, the pattern may be an example of an S-SSB pattern described with reference to FIGS. 2 through 5. For example, the pattern may be based on a quasi co-location relationship between associated pairs of sidelink synchronization signals. In some examples, the UE 615-a may perform the channel access procedure during (or before) the sidelink discovery burst transmission window. At 630, the UE 615-a may transmit (e.g., to the UE 615-b) one or more S-SSBs in accordance with the pattern indicated by the configuration. As a result, the UE 615-a may improve beam pair selection for sidelink communications with the UE 615-b.

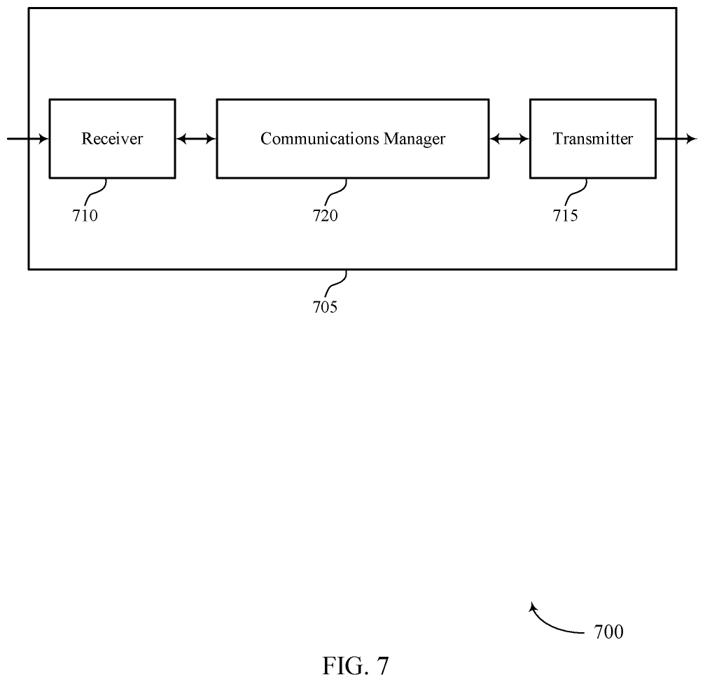

FIG. 7 shows a block diagram 700 of a device 705 that supports a discovery burst transmission window for sidelink communications in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to a discovery burst transmission window for sidelink communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to a discovery burst transmission window for sidelink communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of a discovery burst transmission window for sidelink communications as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE (e.g., the device 705) in accordance with examples as disclosed herein. For example, the communications manager 720 may be configured as or otherwise support a means for receiving a message indicating a configuration of a sidelink discovery burst transmission window including a set of multiple time periods for transmitting a set of multiple sidelink synchronization signals. The communications manager 720 may be configured as or otherwise support a means for performing, during the sidelink discovery burst transmission window, at least one channel access procedure for transmitting at least one sidelink synchronization signal of the set of multiple sidelink synchronization signals according to a pattern indicated by the configuration, the pattern based on a quasi co-location relationship between associated pairs of sidelink synchronization signals. The communications manager 720 may be configured as or otherwise support a means for transmitting, to a second UE (e.g., another device 705) and in accordance with the pattern indicated by the configuration, the at least one sidelink synchronization signal.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing and more efficient utilization of communication resources.

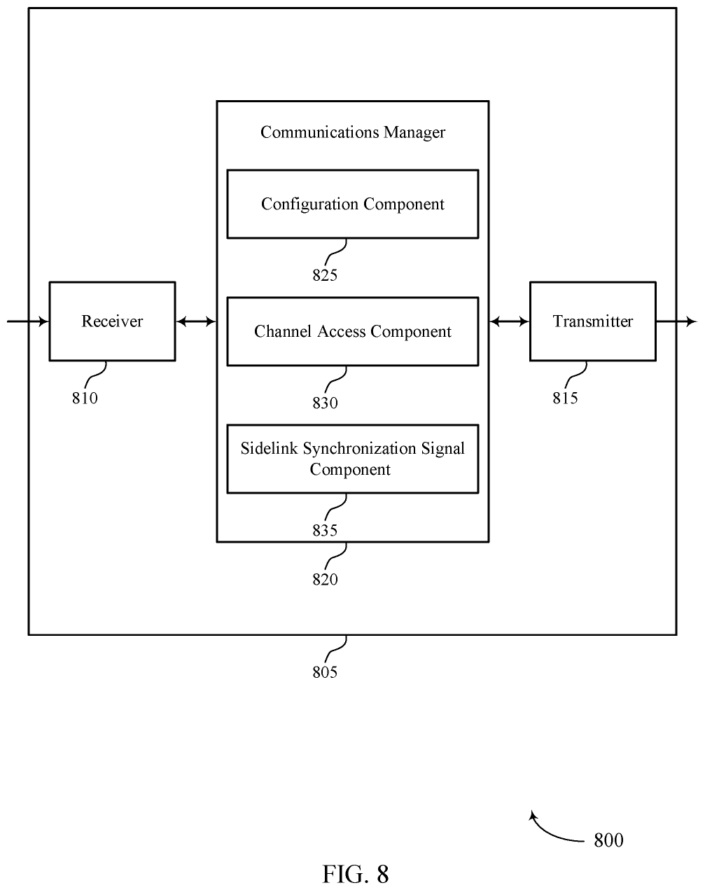

FIG. 8 shows a block diagram 800 of a device 805 that supports a discovery burst transmission window for sidelink communications in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to a discovery burst transmission window for sidelink communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to a discovery burst transmission window for sidelink communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of a discovery burst transmission window for sidelink communications as described herein. For example, the communications manager 820 may include a configuration component 825, a channel access component 830, a sidelink synchronization signal component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first UE (e.g., the device 805) in accordance with examples as disclosed herein. The configuration component 825 may be configured as or otherwise support a means for receiving a message indicating a configuration of a sidelink discovery burst transmission window including a set of multiple time periods for transmitting a set of multiple sidelink synchronization signals. The channel access component 830 may be configured as or otherwise support a means for performing, during the sidelink discovery burst transmission window, at least one channel access procedure for transmitting at least one sidelink synchronization signal of the set of multiple sidelink synchronization signals according to a pattern indicated by the configuration, the pattern based on a quasi co-location relationship between associated pairs of sidelink synchronization signals. The sidelink synchronization signal component 835 may be configured as or otherwise support a means for transmitting, to a second UE (e.g., another device 805) and in accordance with the pattern indicated by the configuration, the at least one sidelink synchronization signal.

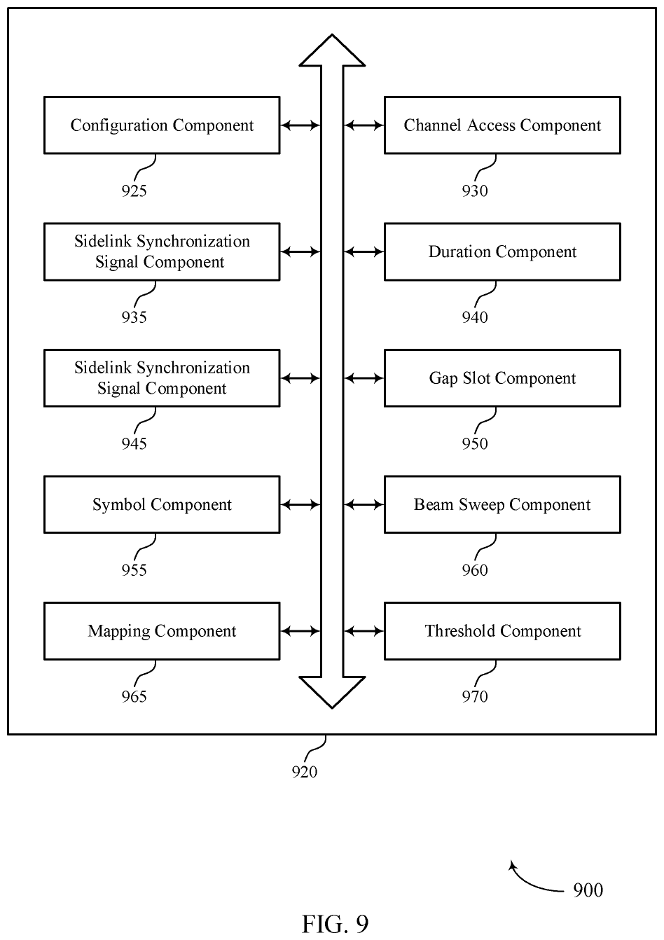

FIG. 9 shows a block diagram 900 of a communications manager 920 that supports a discovery burst transmission window for sidelink communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of a discovery burst transmission window for sidelink communications as described herein. For example, the communications manager 920 may include a configuration component 925, a channel access component 930, a sidelink synchronization signal component 935, a duration component 940, a sidelink synchronization signal component 945, a gap slot component 950, a symbol component 955, a beam sweep component 960, a mapping component 965, a threshold component 970, or any combination thereof. Each of these components may communicate, directly or indirectly, with one another (e.g., via one or more buses).

The communications manager 920 may support wireless communication at a first UE (e.g., a UE 115) in accordance with examples as disclosed herein. The configuration component 925 may be configured as or otherwise support a means for receiving a message indicating a configuration of a sidelink discovery burst transmission window including a set of multiple time periods for transmitting a set of multiple sidelink synchronization signals. The channel access component 930 may be configured as or otherwise support a means for performing, during the sidelink discovery burst transmission window, at least one channel access procedure for transmitting at least one sidelink synchronization signal of the set of multiple sidelink synchronization signals according to a pattern indicated by the configuration, the pattern based on a quasi co-location relationship between associated pairs of sidelink synchronization signals. The sidelink synchronization signal component 935 may be configured as or otherwise support a means for transmitting, to a second UE (e.g., another UE 115) and in accordance with the pattern indicated by the configuration, the at least one sidelink synchronization signal.

In some examples, the configuration of the sidelink discovery burst transmission window includes an indication of a duration of the sidelink discovery burst transmission window. In some examples, the duration component 940 may be configured as or otherwise support a means for receiving RRC signaling indicating the duration of the sidelink discovery burst transmission window.

In some examples, the duration component 940 may be configured as or otherwise support a means for transmitting physical sidelink broadcast channel signaling indicating the duration of the sidelink discovery burst transmission window. In some examples, the duration component 940 may be configured as or otherwise support a means for determining a duration of the sidelink discovery burst transmission window based on a quasi co-location relation factor indicated by the configuration. In some examples, a value of the duration of the sidelink discovery burst transmission window is proportional to the quasi co-location relation factor indicated by the configuration.

In some examples, the threshold component 970 may be configured as or otherwise support a means for determining that a value of the quasi co-location relation factor indicated by the configuration is below a first threshold. In some examples, the threshold component 970 may be configured as or otherwise support a means for calculate a number of candidate sidelink synchronization signal positions within the sidelink discovery burst transmission window based on a measured interference level and determining that the value of the quasi co-location relation factor indicated by the configuration is below the first threshold.

In some examples, the duration component 940 may be configured as or otherwise support a means for identifying a default value for a duration of the sidelink discovery burst transmission window based on an indication of the duration being absent from the configuration.

In some examples, to support transmitting the at least one sidelink synchronization signal, the sidelink synchronization signal component 945 may be configured as or otherwise support a means for transmitting the at least one sidelink synchronization signal during a first instant of multiple instants for transmitting the set of multiple sidelink synchronization signals, where the sidelink discovery burst transmission window includes the multiple instants for transmitting the set of multiple sidelink synchronization signals.

In some examples, to support transmitting the at least one sidelink synchronization signal, the sidelink synchronization signal component 945 may be configured as or otherwise support a means for transmitting the at least one sidelink synchronization signal based on determining a start time for the sidelink discovery burst transmission window in accordance with a sidelink synchronization signal timing offset indicated by the configuration.

In some examples, the gap slot component 950 may be configured as or otherwise support a means for identifying a position of a gap slot within the sidelink discovery burst transmission window based on the pattern, the gap slot configured for receiving an indication of a preferred beam to be used for sidelink communications with the second UE.

In some examples, the symbol component 955 may be configured as or otherwise support a means for determining a location of a first symbol for the at least one sidelink synchronization signal based on a subcarrier spacing configured for the first UE. In some examples, a candidate sidelink synchronization signal position for transmitting the at least one sidelink synchronization signal is based on a subcarrier spacing configured for the first UE and a duration of the sidelink discovery burst transmission window.

In some examples, each slot of at least one slot included in the sidelink discovery burst transmission window corresponds to a respective slot index. In some examples, transmitting a sidelink synchronization signal of the at least one sidelink synchronization signal during a slot is based on a slot index of the slot.

In some examples, to support transmitting the at least one sidelink synchronization signal, the beam sweep component 960 may be configured as or otherwise support a means for performing a beam sweep procedure in each instant of multiple instants for transmitting the set of multiple sidelink synchronization signals, where each discovery burst transmission window includes a single instant.

In some examples, to support transmitting the at least one sidelink synchronization signal, the mapping component 965 may be configured as or otherwise support a means for mapping each sidelink synchronization signal of the at least one sidelink synchronization signal to a respective slot of at least one slot included in at least one sidelink discovery burst transmission window, where mapping each sidelink synchronization signal is based on a signal index associated with each sidelink synchronization signal and a quasi co-location relation factor indicated by the configuration.

In some examples, to support mapping each sidelink synchronization signal of the at least one sidelink synchronization signal, the mapping component 965 may be configured as or otherwise support a means for mapping a first synchronization signal of the at least one sidelink synchronization signal to a first slot in a first position of the sidelink discovery burst transmission window. In some examples, to support mapping each sidelink synchronization signal of the at least one sidelink synchronization signal, the mapping component 965 may be configured as or otherwise support a means for mapping a second sidelink synchronization signal of the at least one sidelink synchronization signal to a second slot in a second position of the sidelink discovery burst transmission window, where a difference between the first position and the second position is based on the quasi co-location relation factor indicated by the configuration, and where the first synchronization signal is quasi co-located with the second sidelink synchronization signal.

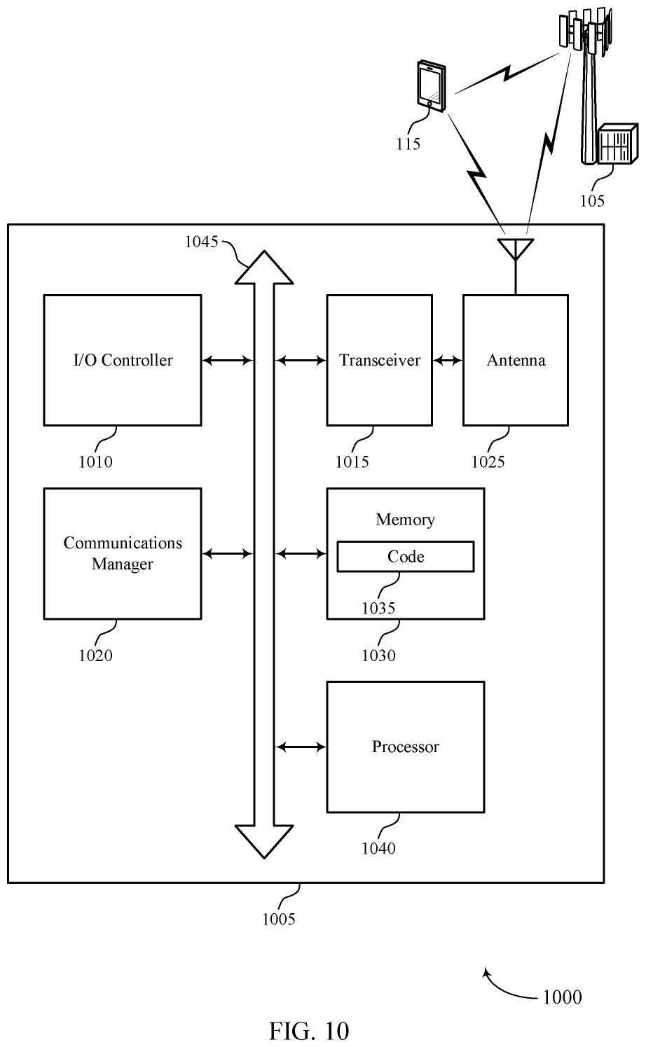

FIG. 10 shows a diagram of a system 1000 including a device 1005 that supports a discovery burst transmission window for sidelink communications in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting a discovery burst transmission window for sidelink communications). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a first UE (e.g., the device 1005) in accordance with examples as disclosed herein. For example, the communications manager 1020 may be configured as or otherwise support a means for receiving a message indicating a configuration of a sidelink discovery burst transmission window including a set of multiple time periods for transmitting a set of multiple sidelink synchronization signals. The communications manager 1020 may be configured as or otherwise support a means for performing, during the sidelink discovery burst transmission window, at least one channel access procedure for transmitting at least one sidelink synchronization signal of the set of multiple sidelink synchronization signals according to a pattern indicated by the configuration, the pattern based on a quasi co-location relationship between associated pairs of sidelink synchronization signals. The communications manager 1020 may be configured as or otherwise support a means for transmitting, to a second UE (e.g., another device 1005) and in accordance with the pattern indicated by the configuration, the at least one sidelink synchronization signal.

By including or configuring the communications manager 1020 in accordance with examples as described herein, the device 1005 may support techniques for improved communication reliability, reduced latency, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of a discovery burst transmission window for sidelink communications as described herein, or the processor 1040 and the memory 1030 may be otherwise configured to perform or support such operations.

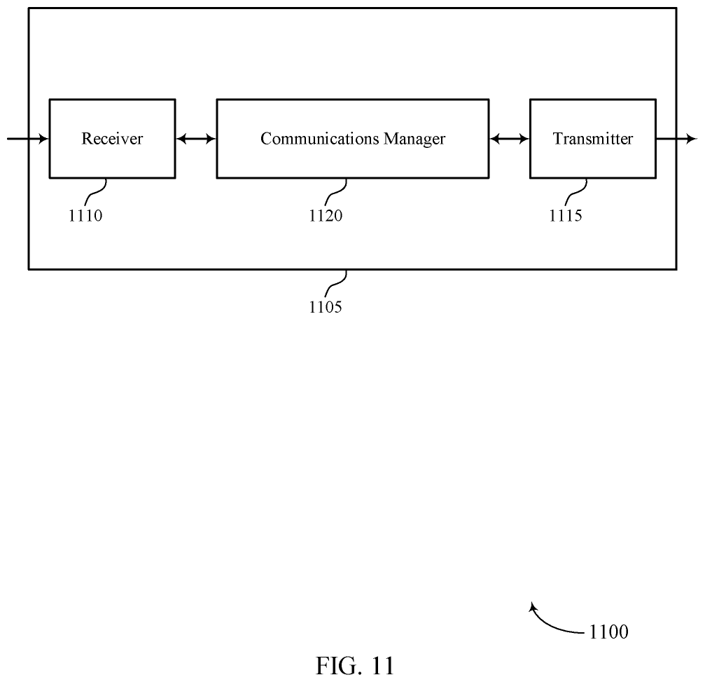

FIG. 11 shows a block diagram 1100 of a device 1105 that supports a discovery burst transmission window for sidelink communications in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of a discovery burst transmission window for sidelink communications as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity (e.g., the device 1105) in accordance with examples as disclosed herein. For example, the communications manager 1120 may be configured as or otherwise support a means for generating a configuration of a sidelink discovery burst transmission window including a set of multiple time periods for transmitting, between a first UE (e.g., a first UE 115) and a second UE (e.g., a second UE 115), a set of multiple sidelink synchronization signals, where the configuration indicates a pattern based on a quasi co-location relationship between associated pairs of sidelink synchronization signals. The communications manager 1120 may be configured as or otherwise support a means for outputting a first indication of the configuration.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced processing and more efficient utilization of communication resources.

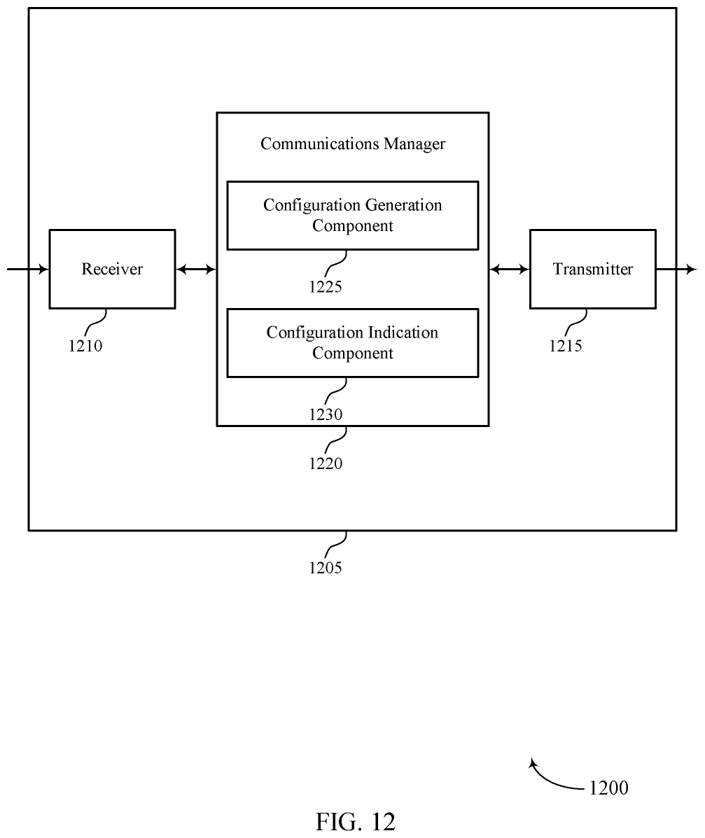

FIG. 12 shows a block diagram 1200 of a device 1205 that supports a discovery burst transmission window for sidelink communications in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of a discovery burst transmission window for sidelink communications as described herein. For example, the communications manager 1220 may include a configuration generation component 1225 a configuration indication component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity (e.g., device 1205) in accordance with examples as disclosed herein. The configuration generation component 1225 may be configured as or otherwise support a means for generating a configuration of a sidelink discovery burst transmission window including a set of multiple time periods for transmitting, between a first UE (e.g., a first UE 115) and a second UE (e.g., a second UE 115), a set of multiple sidelink synchronization signals, where the configuration indicates a pattern based on a quasi co-location relationship between associated pairs of sidelink synchronization signals. The configuration indication component 1230 may be configured as or otherwise support a means for outputting a first indication of the configuration.

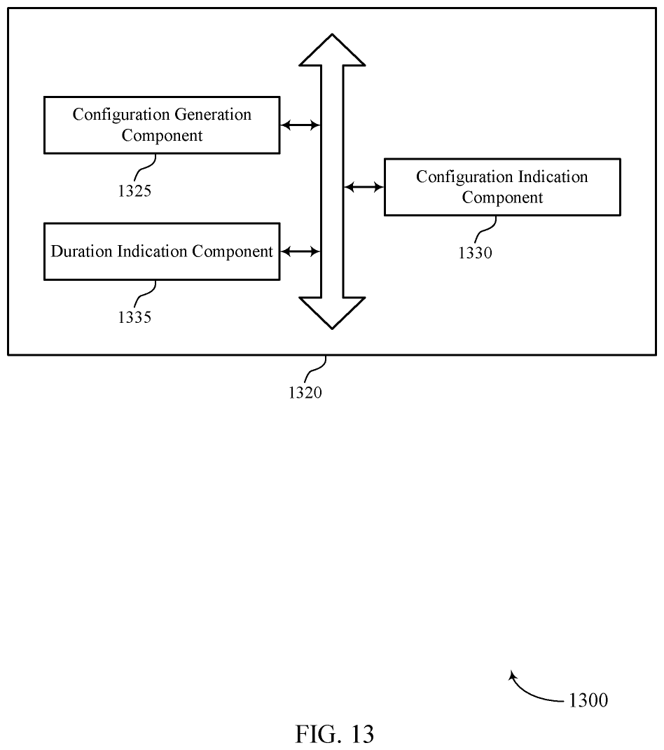

FIG. 13 shows a block diagram 1300 of a communications manager 1320 that supports a discovery burst transmission window for sidelink communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of a discovery burst transmission window for sidelink communications as described herein. For example, the communications manager 1320 may include a configuration generation component 1325, a configuration indication component 1330, a duration indication component 1335, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity (e.g., a network entity 105) in accordance with examples as disclosed herein. The configuration generation component 1325 may be configured as or otherwise support a means for generating a configuration of a sidelink discovery burst transmission window including a set of multiple time periods for transmitting, between a first UE (e.g., a first UE 115) and a second UE (e.g., a second UE 115), a set of multiple sidelink synchronization signals, where the configuration indicates a pattern based on a quasi co-location relationship between associated pairs of sidelink synchronization signals. The configuration indication component 1330 may be configured as or otherwise support a means for outputting a first indication of the configuration.

In some examples, the configuration of the sidelink discovery burst transmission window includes a second indication of a duration of the sidelink discovery burst transmission window. In some examples, the duration indication component 1335 may be configured as or otherwise support a means for generating RRC signaling indicating the duration of the sidelink discovery burst transmission window.

In some examples, a value of the duration of the sidelink discovery burst transmission window is proportional to a quasi co-location relation factor indicated by the configuration. In some examples, candidate sidelink synchronization signal positions for transmitting the set of multiple sidelink synchronization signals is based on a subcarrier spacing configured for the first UE and a duration of the sidelink discovery burst transmission window.

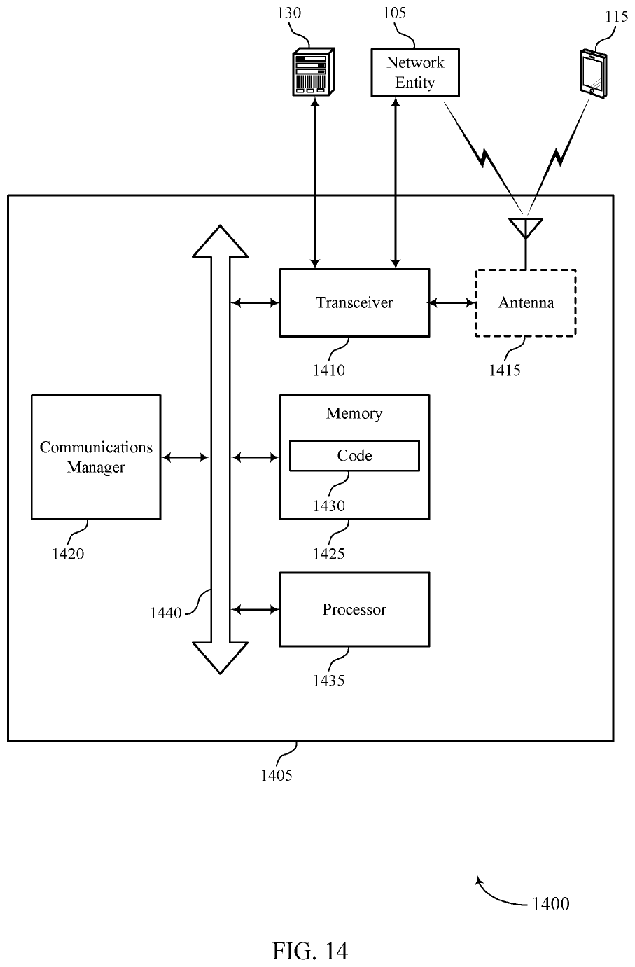

FIG. 14 shows a diagram of a system 1400 including a device 1405 that supports a discovery burst transmission window for sidelink communications in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting a discovery burst transmission window for sidelink communications). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity (e.g., the device 140) in accordance with examples as disclosed herein. For example, the communications manager 1420 may be configured as or otherwise support a means for generating a configuration of a sidelink discovery burst transmission window including a set of multiple time periods for transmitting, between a first UE (e.g., a first UE 115) and a second UE (e.g., a second UE 115), a set of multiple sidelink synchronization signals, where the configuration indicates a pattern based on a quasi co-location relationship between associated pairs of sidelink synchronization signals. The communications manager 1420 may be configured as or otherwise support a means for outputting a first indication of the configuration.

By including or configuring the communications manager 1420 in accordance with examples as described herein, the device 1405 may support techniques for improved communication reliability, reduced latency, more efficient utilization of communication resources, and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of a discovery burst transmission window for sidelink communications as described herein, or the processor 1435 and the memory 1425 may be otherwise configured to perform or support such operations.

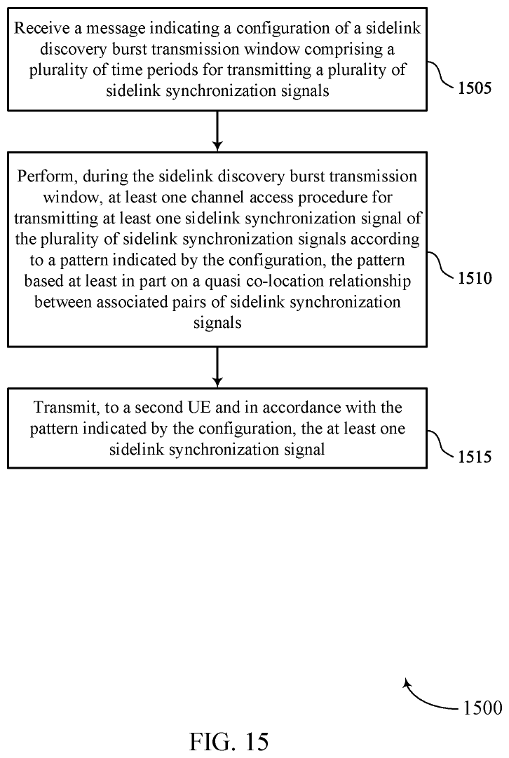

FIG. 15 shows a flowchart illustrating a method 1500 that supports a discovery burst transmission window for sidelink communications in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a message indicating a configuration of a sidelink discovery burst transmission window including a set of multiple time periods for transmitting a set of multiple sidelink synchronization signals. The operations of 1505 may be performed in accordance with examples as disclosed herein. In some examples, aspects of the operations of 1505 may be performed by a configuration component 925 as described with reference to FIG. 9.

At 1510, the method may include performing, during the sidelink discovery burst transmission window, at least one channel access procedure for transmitting at least one sidelink synchronization signal of the set of multiple sidelink synchronization signals according to a pattern indicated by the configuration, the pattern based on a quasi co-location relationship between associated pairs of sidelink synchronization signals. The operations of 1510 may be performed in accordance with examples as disclosed herein. In some examples, aspects of the operations of 1510 may be performed by a channel access component 930 as described with reference to FIG. 9.

At 1515, the method may include transmitting, to a second UE and in accordance with the pattern indicated by the configuration, the at least one sidelink synchronization signal. The operations of 1515 may be performed in accordance with examples as disclosed herein. In some examples, aspects of the operations of 1515 may be performed by a sidelink synchronization signal component 935 as described with reference to FIG. 9.

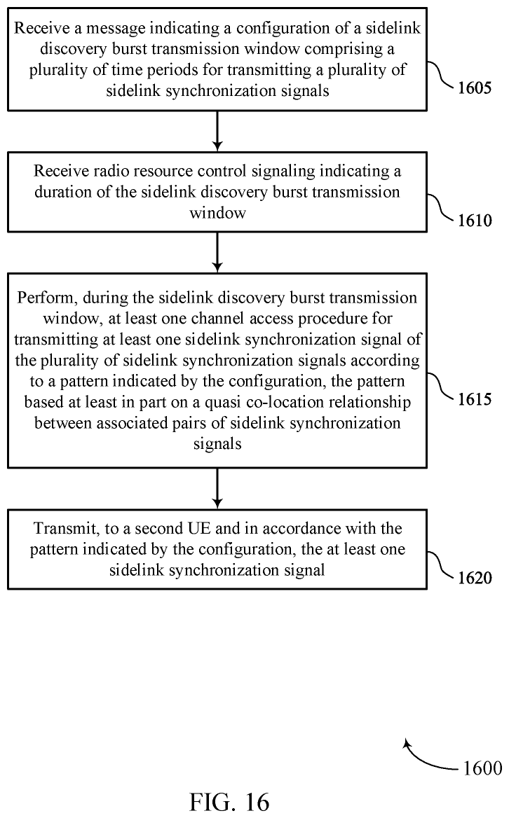

FIG. 16 shows a flowchart illustrating a method 1600 that supports a discovery burst transmission window for sidelink communications in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a message indicating a configuration of a sidelink discovery burst transmission window including a set of multiple time periods for transmitting a set of multiple sidelink synchronization signals. The operations of 1605 may be performed in accordance with examples as disclosed herein. In some examples, aspects of the operations of 1605 may be performed by a configuration component 925 as described with reference to FIG. 9.

At 1610, the method may include receiving RRC signaling indicating a duration of the sidelink discovery burst transmission window. The operations of 1610 may be performed in accordance with examples as disclosed herein. In some examples, aspects of the operations of 1610 may be performed by a duration component 940 as described with reference to FIG. 9.

At 1615, the method may include performing, during the sidelink discovery burst transmission window, at least one channel access procedure for transmitting at least one sidelink synchronization signal of the set of multiple sidelink synchronization signals according to a pattern indicated by the configuration, the pattern based on a quasi co-location relationship between associated pairs of sidelink synchronization signals. The operations of 1615 may be performed in accordance with examples as disclosed herein. In some examples, aspects of the operations of 1615 may be performed by a channel access component 930 as described with reference to FIG. 9.

At 1620, the method may include transmitting, to a second UE and in accordance with the pattern indicated by the configuration, the at least one sidelink synchronization signal. The operations of 1620 may be performed in accordance with examples as disclosed herein. In some examples, aspects of the operations of 1620 may be performed by a sidelink synchronization signal component 935 as described with reference to FIG. 9.

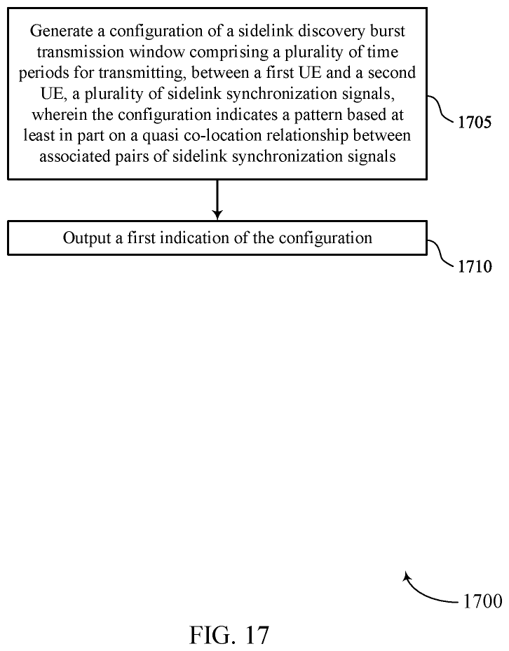

FIG. 17 shows a flowchart illustrating a method 1700 that supports a discovery burst transmission window for sidelink communications in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include generating a configuration of a sidelink discovery burst transmission window including a set of multiple time periods for transmitting, between a first UE and a second UE, a set of multiple sidelink synchronization signals, where the configuration indicates a pattern based on a quasi co-location relationship between associated pairs of sidelink synchronization signals. The operations of 1705 may be performed in accordance with examples as disclosed herein. In some examples, aspects of the operations of 1705 may be performed by a configuration generation component 1325 as described with reference to FIG. 13.

At 1710, the method may include outputting a first indication of the configuration. The operations of 1710 may be performed in accordance with examples as disclosed herein. In some examples, aspects of the operations of 1710 may be performed by a configuration indication component 1330 as described with reference to FIG. 13.

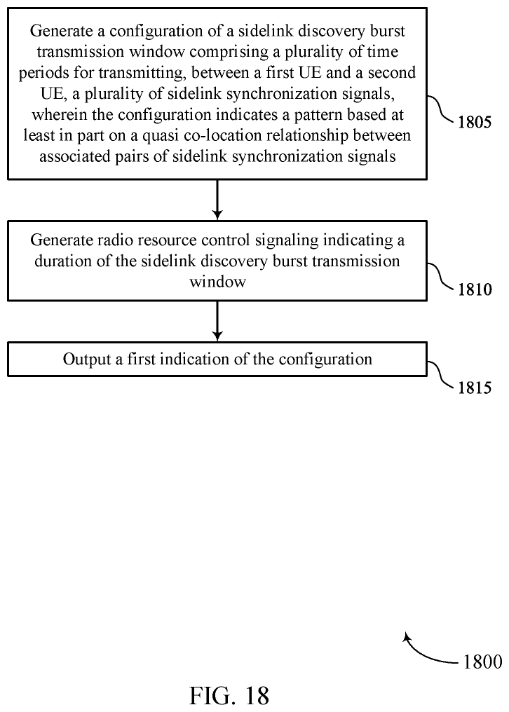

FIG. 18 shows a flowchart illustrating a method 1800 that supports a discovery burst transmission window for sidelink communications in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include generating a configuration of a sidelink discovery burst transmission window including a set of multiple time periods for transmitting, between a first UE and a second UE, a set of multiple sidelink synchronization signals, where the configuration indicates a pattern based on a quasi co-location relationship between associated pairs of sidelink synchronization signals. The operations of 1805 may be performed in accordance with examples as disclosed herein. In some examples, aspects of the operations of 1805 may be performed by a configuration generation component 1325 as described with reference to FIG. 13.

At 1810, the method may include generating RRC signaling indicating a duration of the sidelink discovery burst transmission window. The operations of 1810 may be performed in accordance with examples as disclosed herein. In some examples, aspects of the operations of 1810 may be performed by a duration indication component 1335 as described with reference to FIG. 13.

At 1815, the method may include outputting a first indication of the configuration. The operations of 1815 may be performed in accordance with examples as disclosed herein. In some examples, aspects of the operations of 1815 may be performed by a configuration indication component 1330 as described with reference to FIG. 13.

The following provides an overview of aspects of the present disclosure:

Aspect 1: A method for wireless communication at a first UE, comprising: receiving a message indicating a configuration of a sidelink discovery burst transmission window comprising a plurality of time periods for transmitting a plurality of sidelink synchronization signals; performing, during the sidelink discovery burst transmission window, at least one channel access procedure for transmitting at least one sidelink synchronization signal of the plurality of sidelink synchronization signals according to a pattern indicated by the configuration, the pattern based at least in part on a quasi co-location relationship between associated pairs of sidelink synchronization signals; and transmitting, to a second UE and in accordance with the pattern indicated by the configuration, the at least one sidelink synchronization signal.

Aspect 2: The method of aspect 1, wherein the configuration of the sidelink discovery burst transmission window comprises an indication of a duration of the sidelink discovery burst transmission window.

Aspect 3: The method of aspect 2, further comprising: receiving RRC signaling indicating the duration of the sidelink discovery burst transmission window.

Aspect 4: The method of any of aspects 2 through 3, further comprising: transmitting physical sidelink broadcast channel signaling indicating the duration of the sidelink discovery burst transmission window.

Aspect 5: The method of any of aspects 1 through 4, further comprising: determining a duration of the sidelink discovery burst transmission window based at least in part on a quasi co-location relation factor indicated by the configuration.

Aspect 6: The method of aspect 5, wherein a value of the duration of the sidelink discovery burst transmission window is proportional to the quasi co-location relation factor indicated by the configuration.

Aspect 7: The method of any of aspects 5 through 6, further comprising: determining that a value of the quasi co-location relation factor indicated by the configuration is below a first threshold; and calculate a number of candidate sidelink synchronization signal positions within the sidelink discovery burst transmission window based at least in part on a measured interference level and determining that the value of the quasi co-location relation factor indicated by the configuration is below the first threshold.

Aspect 8: The method of any of aspects 1 through 7, further comprising: identifying a default value for a duration of the sidelink discovery burst transmission window based at least in part on an indication of the duration being absent from the configuration.

Aspect 9: The method of any of aspects 1 through 8, wherein transmitting the at least one sidelink synchronization signal comprises: transmitting the at least one sidelink synchronization signal during a first instant of multiple instants for transmitting the plurality of sidelink synchronization signals, wherein the sidelink discovery burst transmission window comprises the multiple instants for transmitting the plurality of sidelink synchronization signals.

Aspect 10: The method of any of aspects 1 through 9, wherein transmitting the at least one sidelink synchronization signal comprises: transmitting the at least one sidelink synchronization signal based at least in part on determining a start time for the sidelink discovery burst transmission window in accordance with a sidelink synchronization signal timing offset indicated by the configuration.

Aspect 11: The method of any of aspects 1 through 10, further comprising: identifying a position of a gap slot within the sidelink discovery burst transmission window based at least in part on the pattern, the gap slot configured for receiving an indication of a preferred beam to be used for sidelink communications with the second UE.

Aspect 12: The method of any of aspects 1 through 11, further comprising: determining a location of a first symbol for the at least one sidelink synchronization signal based at least in part on a subcarrier spacing configured for the first UE.

Aspect 13: The method of any of aspects 1 through 12, wherein a candidate sidelink synchronization signal position for transmitting the at least one sidelink synchronization signal is based at least in part on a subcarrier spacing configured for the first UE and a duration of the sidelink discovery burst transmission window.

Aspect 14: The method of aspect 13, wherein each slot of at least one slot included in the sidelink discovery burst transmission window corresponds to a respective slot index, and transmitting a sidelink synchronization signal of the at least one sidelink synchronization signal during a slot is based at least in part on a slot index of the slot.

Aspect 15: The method of any of aspects 1 through 14, wherein transmitting the at least one sidelink synchronization signal comprises: performing a beam sweep procedure in each instant of multiple instants for transmitting the plurality of sidelink synchronization signals, wherein each discovery burst transmission window comprises a single instant.

Aspect 16: The method of any of aspects 1 through 15, wherein transmitting the at least one sidelink synchronization signal comprises: mapping each sidelink synchronization signal of the at least one sidelink synchronization signal to a respective slot of at least one slot included in at least one sidelink discovery burst transmission window, wherein mapping each sidelink synchronization signal is based at least in part on a signal index associated with each sidelink synchronization signal and a quasi co-location relation factor indicated by the configuration.

Aspect 17: The method of aspect 16, wherein mapping each sidelink synchronization signal of the at least one sidelink synchronization signal further comprises: mapping a first synchronization signal of the at least one sidelink synchronization signal to a first slot in a first position of the sidelink discovery burst transmission window; and mapping a second sidelink synchronization signal of the at least one sidelink synchronization signal to a second slot in a second position of the sidelink discovery burst transmission window, wherein a difference between the first position and the second position is based at least in part on the quasi co-location relation factor indicated by the configuration, and wherein the first synchronization signal is quasi co-located with the second sidelink synchronization signal.

Aspect 18: A method for wireless communication at a network entity, comprising: generating a configuration of a sidelink discovery burst transmission window comprising a plurality of time periods for transmitting, between a first UE and a second UE, a plurality of sidelink synchronization signals, wherein the configuration indicates a pattern based at least in part on a quasi co-location relationship between associated pairs of sidelink synchronization signals; and outputting a first indication of the configuration.

Aspect 19: The method of aspect 18, wherein the configuration of the sidelink discovery burst transmission window comprises a second indication of a duration of the sidelink discovery burst transmission window.

Aspect 20: The method of aspect 19, further comprising: generating RRC signaling indicating the duration of the sidelink discovery burst transmission window.

Aspect 21: The method of any of aspects 19 through 20, wherein a value of the duration of the sidelink discovery burst transmission window is proportional to a quasi co-location relation factor indicated by the configuration.

Aspect 22: The method of any of aspects 18 through 21, wherein candidate sidelink synchronization signal positions for transmitting the plurality of sidelink synchronization signals is based at least in part on a subcarrier spacing configured for the first UE and a duration of the sidelink discovery burst transmission window.

Aspect 23: An apparatus for wireless communication at a first UE, comprising a processor; memory coupled with the processor; and instructions stored in the memory and executable by the processor to cause the apparatus to perform a method of any of aspects 1 through 17.

Aspect 24: An apparatus for wireless communication at a first UE, comprising at least one means for performing a method of any of aspects 1 through 17.

Aspect 25: A non-transitory computer-readable medium storing code for wireless communication at a first UE, the code comprising instructions executable by a processor to perform a method of any of aspects 1 through 17.

Aspect 26: An apparatus for wireless communication at a network entity, comprising a processor; memory coupled with the processor; and instructions stored in the memory and executable by the processor to cause the apparatus to perform a method of any of aspects 18 through 22.

Aspect 27: An apparatus for wireless communication at a network entity, comprising at least one means for performing a method of any of aspects 18 through 22.

Aspect 28: A non-transitory computer-readable medium storing code for wireless communication at a network entity, the code comprising instructions executable by a processor to perform a method of any of aspects 18 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
receiving a message indicating a configuration of a sidelink discovery burst transmission window comprising a plurality of time periods for transmitting a plurality of sidelink synchronization signals;
performing, during the sidelink discovery burst transmission window, at least one channel access procedure for transmitting at least one sidelink synchronization signal of the plurality of sidelink synchronization signals according to a pattern indicated by the configuration, the pattern based at least in part on a quasi co-location relationship between associated pairs of sidelink synchronization signals; and
transmitting, to a second UE and in accordance with the pattern indicated by the configuration, the at least one sidelink synchronization signal.

2. The method of claim 1, wherein the configuration of the sidelink discovery burst transmission window comprises an indication of a duration of the sidelink discovery burst transmission window.

3. The method of claim 2, further comprising:
receiving radio resource control signaling indicating the duration of the sidelink discovery burst transmission window.

4. The method of claim 2, further comprising:
transmitting physical sidelink broadcast channel signaling indicating the duration of the sidelink discovery burst transmission window.

5. The method of claim 1, further comprising:
determining a duration of the sidelink discovery burst transmission window based at least in part on a quasi co-location relation factor indicated by the configuration.

6. The method of claim 5, wherein a value of the duration of the sidelink discovery burst transmission window is proportional to the quasi co-location relation factor indicated by the configuration.

7. The method of claim 5, further comprising:
determining that a value of the quasi co-location relation factor indicated by the configuration is below a first threshold; and
calculate a number of candidate sidelink synchronization signal positions within the sidelink discovery burst transmission window based at least in part on a measured interference level and determining that the value of the quasi co-location relation factor indicated by the configuration is below the first threshold.

8. The method of claim 1, further comprising:
identifying a default value for a duration of the sidelink discovery burst transmission window based at least in part on an indication of the duration being absent from the configuration.

9. The method of claim 1, wherein transmitting the at least one sidelink synchronization signal comprises:
transmitting the at least one sidelink synchronization signal during a first instant of multiple instants for transmitting the plurality of sidelink synchronization signals, wherein the sidelink discovery burst transmission window comprises the multiple instants for transmitting the plurality of sidelink synchronization signals.

10. The method of claim 1, wherein transmitting the at least one sidelink synchronization signal comprises:
transmitting the at least one sidelink synchronization signal based at least in part on determining a start time for the sidelink discovery burst transmission window in accordance with a sidelink synchronization signal timing offset indicated by the configuration.

11. The method of claim 1, further comprising:
identifying a position of a gap slot within the sidelink discovery burst transmission window based at least in part on the pattern, the gap slot configured for receiving an indication of a preferred beam to be used for sidelink communications with the second UE.

12. The method of claim 1, further comprising:
determining a location of a first symbol for the at least one sidelink synchronization signal based at least in part on a subcarrier spacing configured for the first UE.

13. The method of claim 1, wherein a candidate sidelink synchronization signal position for transmitting the at least one sidelink synchronization signal is based at least in part on a subcarrier spacing configured for the first UE and a duration of the sidelink discovery burst transmission window.

14. The method of claim 13, wherein:
each slot of at least one slot included in the sidelink discovery burst transmission window corresponds to a respective slot index, and
transmitting a sidelink synchronization signal of the at least one sidelink synchronization signal during a slot is based at least in part on a slot index of the slot.

15. The method of claim 1, wherein transmitting the at least one sidelink synchronization signal comprises:
performing a beam sweep procedure in each instant of multiple instants for transmitting the plurality of sidelink synchronization signals, wherein each discovery burst transmission window comprises a single instant.

16. The method of claim 1, wherein transmitting the at least one sidelink synchronization signal comprises:
mapping each sidelink synchronization signal of the at least one sidelink synchronization signal to a respective slot of at least one slot included in at least one sidelink discovery burst transmission window, wherein mapping each sidelink synchronization signal is based at least in part on a signal index associated with each sidelink synchronization signal and a quasi co-location relation factor indicated by the configuration.

17. The method of claim 16, wherein mapping each sidelink synchronization signal of the at least one sidelink synchronization signal further comprises:
mapping a first synchronization signal of the at least one sidelink synchronization signal to a first slot in a first position of the sidelink discovery burst transmission window; and
mapping a second sidelink synchronization signal of the at least one sidelink synchronization signal to a second slot in a second position of the sidelink discovery burst transmission window, wherein a difference between the first position and the second position is based at least in part on the quasi co-location relation factor indicated by the configuration, and wherein the first synchronization signal is quasi co-located with the second sidelink synchronization signal.

18. A method for wireless communication at a network entity, comprising:
generating a configuration of a sidelink discovery burst transmission window comprising a plurality of time periods for transmitting, between a first user equipment (UE) and a second UE, a plurality of sidelink synchronization signals, wherein the configuration indicates a pattern based at least in part on a quasi co-location relationship between associated pairs of sidelink synchronization signals; and
outputting a first indication of the configuration.

19. The method of claim 18, wherein the configuration of the sidelink discovery burst transmission window comprises a second indication of a duration of the sidelink discovery burst transmission window.

20. The method of claim 19, further comprising:
generating radio resource control signaling indicating the duration of the sidelink discovery burst transmission window.

21. The method of claim 19, wherein a value of the duration of the sidelink discovery burst transmission window is proportional to a quasi co-location relation factor indicated by the configuration.

22. The method of claim 18, wherein candidate sidelink synchronization signal positions for transmitting the plurality of sidelink synchronization signals is based at least in part on a subcarrier spacing configured for the first UE and a duration of the sidelink discovery burst transmission window.

23. An apparatus for wireless communication at a first user equipment (UE), comprising:
a processor;
memory coupled with the processor; and
instructions stored in the memory and executable by the processor to cause the apparatus to:
receive a message indicating a configuration of a sidelink discovery burst transmission window comprising a plurality of time periods for transmitting a plurality of sidelink synchronization signals;
perform, during the sidelink discovery burst transmission window, at least one channel access procedure for transmitting at least one sidelink synchronization signal of the plurality of sidelink synchronization signals according to a pattern indicated by the configuration, the pattern based at least in part on a quasi co-location relationship between associated pairs of sidelink synchronization signals; and
transmit, to a second UE and in accordance with the pattern indicated by the configuration, the at least one sidelink synchronization signal.

24. The apparatus of claim 23, wherein the configuration of the sidelink discovery burst transmission window comprises an indication of a duration of the sidelink discovery burst transmission window.

25. The apparatus of claim 24, wherein the instructions are further executable by the processor to cause the apparatus to:
receive radio resource control signaling indicating the duration of the sidelink discovery burst transmission window.

26. The apparatus of claim 24, wherein the instructions are further executable by the processor to cause the apparatus to:
transmit physical sidelink broadcast channel signaling indicating the duration of the sidelink discovery burst transmission window.

27. The apparatus of claim 23, wherein the instructions are further executable by the processor to cause the apparatus to:
determine a duration of the sidelink discovery burst transmission window based at least in part on a quasi co-location relation factor indicated by the configuration.

28. The apparatus of claim 23, wherein the instructions to transmit the at least one sidelink synchronization signal are executable by the processor to cause the apparatus to:
transmit the at least one sidelink synchronization signal during a first instant of multiple instants for transmitting the plurality of sidelink synchronization signals, wherein the sidelink discovery burst transmission window comprises the multiple instants for transmitting the plurality of sidelink synchronization signals.

29. An apparatus for wireless communication at a network entity, comprising:
a processor;
memory coupled with the processor; and
instructions stored in the memory and executable by the processor to cause the apparatus to:
generate a configuration of a sidelink discovery burst transmission window comprising a plurality of time periods for transmitting, between a first user equipment (UE) and a second UE, a plurality of sidelink synchronization signals, wherein the configuration indicates a pattern based at least in part on a quasi co-location relationship between associated pairs of sidelink synchronization signals; and
output a first indication of the configuration.

30. The apparatus of claim 29, wherein the configuration of the sidelink discovery burst transmission window comprises a second indication of a duration of the sidelink discovery burst transmission window.
